(19) United States
(12) Patent Application Publication
(10) Pub. No.: US 2022/0075477 A1
(43) Pub. Date: Mar. 10, 2022

(54) SYSTEMS AND/OR METHODS FOR PARALLAX CORRECTION IN LARGE AREA TRANSPARENT TOUCH INTERFACES

(71) Applicant: GUARDIAN GLASS, LLC, AUBURN HILLS, MI (US)

(72) Inventor: ALEXANDER SOBOLEV, WEST BLOOMFIELD, MI (US)

(73) Assignee: GUARDIAN GLASS, LLC, AUBURN HILLS, MI (US)

(21) Appl. No.: 17/419,379

(22) PCT Filed: Dec. 31, 2019
(86) PCT No.: PCT/IB2019/061453

§ 371 Date: Jun. 29, 2021

Related U.S. Application Data
(60) Provisional application No. 62/786,679, filed on Dec. 31, 2018.

(51) Int. Cl. G06F 3/041; G06F 3/0488; G06F 3/01; G06F 3/044

(52) U.S. Cl. CPC G06F 3/0418; G06F 3/0488; G06F 2203/04108; G06F 3/012; G06F 3/044; G06F 3/013

(57) ABSTRACT

Certain example embodiments of this invention relate to dynamically determining perspective for parallax correction purposes, e.g., in situations where large area transparent touch interfaces and/or the like are implemented. By leveraging computer vision software libraries and one or more cameras to detect the location of a user's viewpoint and a capacitive touch panel to detect a point that has been touched by that user in real time, it becomes possible to identify a three-dimensional vector that passes through the touch panel and towards any/all targets that are in the user's field of view. If this vector intersects a target, that target is selected as the focus of a user's touch and appropriate feedback can be given. These techniques advantageously make it possible for users to interact with one or more physical or virtual objects of interest “beyond” a transparent touch panel.

This application claims the benefit of U.S. Provisional Application Ser. No. 62/786,679 filed on Dec. 31, 2018, the entire contents of which are hereby incorporated by reference herein.

### TECHNICAL FIELD

Certain example embodiments of this invention relate to systems and/or methods for parallax correction in large area transparent touch interfaces. More particularly, certain example embodiments of this invention relate to dynamically determining perspective for parallax correction purposes, e.g., in situations where large area transparent touch interfaces and/or the like are implemented.

### BACKGROUND AND SUMMARY

When users interact with touch panels, they typically point to the object they see behind the glass. When the object appears to be on the glass or other transparent surface of the touch panel, it is fairly straightforward to implement a software-based interface for correlating touch points with object locations. This typically is the case with smartphone, tablet, laptop, and other portable and often handheld displays and touch interfaces.

FIG. 1, for example, schematically shows the fairly straightforward case of an object of interest 100 being located “on” the back (non-user-facing) side of a touch panel 102. A first human user 104a is able to touch the front (user-facing) surface of the touch panel 102 to select or otherwise interact with the object of interest 100. Because the object of interest 100 is proximate to the touch location, it is easy to correlate the touch points (e.g., using X-Y coordinates mapped to the touch panel 102) with the location of the object of interest 100. There is a close correspondence between where the user's gaze 106a intersects the front (user-facing) surface of the touch panel 102, and where the object of interest 100 is located.

If an object of interest moves “off” of the touch plane (as may happen when a thicker glass is used, when there is a gap between the touch sensor and the display, etc.), correlating touch input locations with where the object appears to be to users can become more difficult. There might, for example, be a displacement of image location and touch input location.

This displacement is shown schematically in FIG. 2. That is, FIG. 2 schematically shows the case of an object of interest 100′ being located “behind”, “off of”, or spaced apart from, the back (non-user-facing) side of the touch panel 102. The first human user 104a attempting to touch the front (user-facing) surface of the touch panel 102 to select or otherwise interact with the object of interest 100′ might encounter difficulties because the object of interest 100′ is spaced apart from the touch location. There is no longer a close correspondence between where the user's gaze 106a′ intersects the front (user-facing) surface of the touch panel 102, the touch location on the touch panel 102, and where the object of interest 100′ is located relative to the touch panel 102. As noted above, this situation might arise if the object of interest 100′ is moved, if the object of interest 100′ is still on the back surface of the touch panel 102 but there is a large gap between the front touch interface and the back surface, if the glass or other transparent medium in the touch panel 102 is thick, etc.

Current techniques for addressing this issue include correcting for known displacements, making assumptions based on assumed viewing angles, etc. Although it sometimes may be possible to take into account known displacements (e.g., based on static and known factors like glass thickness, configuration of the touch panel, etc.), assumptions cannot always be made concerning viewing angles. For example, FIG. 3 schematically shows first and second human users 104a, 104b with different viewing angles 106a′, 106b′ attempting to interact with the object of interest 100′, which is located “behind”, “off of”, or spaced apart from, the back (non-user-facing) side of a touch panel 102. The first and second users 104a, 104b clearly touch different locations on touch panel 102 in attempting to select or otherwise interact with the object of interest 100′. In essence, if the viewing angle changes from person-to-person, there basically will be guaranteed displacements as between the different touch input locations and the image location. Even if a single user attempts to interact with the object, this current approach cannot always dynamically adjust to changes in that one person's viewing angle that might result if the user moves side-to-side, up-and-down, in-and-out, angles himself/herself relative to the surface of the touch panel, etc. Thus, current solutions are not always very effective when accounting for dynamic movements.

FIG. 4 schematically shows how the displacement problem of FIG. 3 is exacerbated as the object of interest 100″ moves farther and farther away from the touch panel 102. That is, it easily can be seen from FIG. 4 that the difference between touch input locations from different user perspectives increases based on the different gaze angles 106a″ and 106b″, e.g., with the movement of the object of interest to different locations. Even though both users 104a, 104b are pointing at the same object, their touch input is at dramatically different locations on the touch panel 102. With existing touch technologies, this difference oftentimes will result in erroneous selections and/or associated operations.

The issues described above have been discussed in connection with objects having locations known in advance. These issues can become yet more problematic if the object(s) location(s) are not known in advance and/or are dynamic. Thus, it will be appreciated that for touch interfaces to work effectively under a variety of conditions (e.g., for users of different heights and/or positions, for a single user moving, for objects at different positions, for a single object that moves, for people with different visual acuteness levels and/or mobility and/or understanding of how touch interfaces in general work, etc.), it would be desirable to provide techniques that dynamically adjust for different user perspectives relative to one or more objects of interest.

In general, when looking through a transparent plane from different viewing locations/angles (including, for example, off-normal angles), the distance between the plane and any given object behind it creates a visibly perceived displacement of alignment (parallax) between the given object and the plane. Based on the above, and in the context of a transparent touch panel, for example, the distance between the touch plane and the display plane creates a displacement between the object being interacted with and its perceived position. The greater the distance of the object, the greater this displacement appears to the viewer. Thus, although the parallax effect is controllable in conventional, small area displays, it can become significant as display sizes become larger, as objects to be interacted with become farther spaced from the touch and display planes, etc. For instance, the parallax problem can be particularly problematic for vending machines with touch glass interfaces, smart windows in buildings, cars, museum exhibits, wayfinding applications, observation areas, etc.

The parallax problem is born from using a transparent plane as a touch interface to select objects (either real or on a screen) placed at a distance. The visual displacement of selectable objects behind the touch plane means that the location a user must physically touch on the front of the touch plane is also displaced in a manner that is directly affected by their current viewing location/angle.

Certain example embodiments address these and/or other concerns. For instance, certain example embodiments of this invention relate to techniques for touch interfaces that dynamically adjust for different user perspectives relative to one or more objects of interest. Certain example embodiments relate to compensating for parallax issues, e.g., by dynamically determining whether chosen locations on the touch plane correspond to selectable objects from the user's perspective.

Certain example embodiments of this invention relate to dynamically determining perspective for parallax correction purposes, e.g., in situations where large area transparent touch interfaces and/or the like are implemented. By leveraging computer vision software libraries and one or more cameras to detect the location of a user's viewpoint and a capacitive touch panel to detect a point that has been touched by that user in real time, it becomes possible to identify a three-dimensional vector that passes through the touch panel and towards any/all targets that are in the user's field of view. If this vector intersects a target, that target is selected as the focus of a user's touch and appropriate feedback can be given. These techniques advantageously make it possible for users to interact with one or more physical or virtual objects of interest “beyond” a transparent touch panel.

In certain example embodiments, an augmented reality system is provided. At least one transparent touch panel at a fixed position is interposed between a viewing location and a plurality of objects of interest, each said object of interest having a respective location representable in a common coordinate system. At least one camera is oriented generally toward the viewing location. Processing resources include at least one processor and a memory. The processing resources are configured to determine, from touch-related data received from the at least one transparent touch panel, whether a touch-down event has taken place. The processing resources are configured to are further configured to, responsive to a determination that a touch-down event has taken place: determine, from the received touch-related data, touch coordinates associated with the touch-down event that has taken place; obtain an image of the viewing location from the at least one camera; calculate, from body tracking and/or a face recognized in the obtained image, gaze coordinates; transform the touch coordinates and the gaze coordinates into corresponding coordinates in the common coordinate system; determine whether one of the locations in the common coordinate system comes within a threshold distance of a virtual line extending from the gaze coordinates in the common coordinate system through and beyond the touch coordinates in the common coordinate system; and responsive to a determination that one of the locations in the common coordinate system comes within a threshold distance of a virtual line extending from the gaze coordinates in the common coordinate system through and beyond the touch coordinates in the common coordinate system, designate the object of interest associated with that one of the locations as a touched object and generate audio and/or visual output tailored for the touched object.

In certain example embodiments, an augmented reality system is provided. A plurality of transparent touch panels are interposed between a viewing location and a plurality of objects of interest, with each said object of interest having a respective physical location representable in a common coordinate system. An event bus is configured to receive touch-related events published thereto by the transparent touch panels, with each touch-related event including an identifier of the transparent touch panel that published it. At least one camera is oriented generally toward the viewing location. A controller is configured to subscribe to the touch-related events published to the event bus and determine, from touch-related data extracted from touch-related events received over the event bus, whether a tap has taken place. The controller is further configured to, responsive to a determination that a tap has taken place: determine, from the touch-related data, touch coordinates associated with the tap that has taken place, the touch coordinates being representable in the common coordinate system; determine which one of the transparent touch panels was tapped; obtain an image of the viewing location from the at least one camera; calculate, from body tracking and/or a face recognized in the obtained image, gaze coordinates, the gaze coordinates being representable in the common coordinate system; determine whether one of the physical locations in the common coordinate system comes within a threshold distance of a virtual line extending from the gaze coordinates in the common coordinate system through and beyond the touch coordinates in the common coordinate system; and responsive to a determination that one of the physical locations in the common coordinate system comes within a threshold distance of a virtual line extending from the gaze coordinates in the common coordinate system through and beyond the touch coordinates in the common coordinate system, designate the object of interest associated with that one of the physical locations as a touched object and generate visual output tailored for the touched object.

In certain example embodiments, a method of using the system of any of the two preceding paragraphs and the systems described below is provided. In certain example embodiments, a method of configuring the system of any of the two preceding paragraphs and the systems described below is provided. In certain example embodiments, there is provided a non-transitory computer readable storage medium tangibly storing a program including instructions that, when executed by a computer, carry out one or both of such methods. In certain example embodiments, there is provided a controller for use with the system of any of the two preceding paragraphs and the systems described below. In certain example embodiments, there is provided a transparent touch panel for use with the system of any of the two preceding paragraphs and the systems described below. Furthermore, as will be appreciated from the description below, different end-devices/applications may be used in connection with the techniques of any of the two preceding paragraphs and the systems described below. These end-devices include, for example, storefront, in-store displays, museum exhibits, insulating glass (IG) window or other units, etc.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 schematically shows an object of interest being located “on” the back (non-user-facing) side of a touch panel;

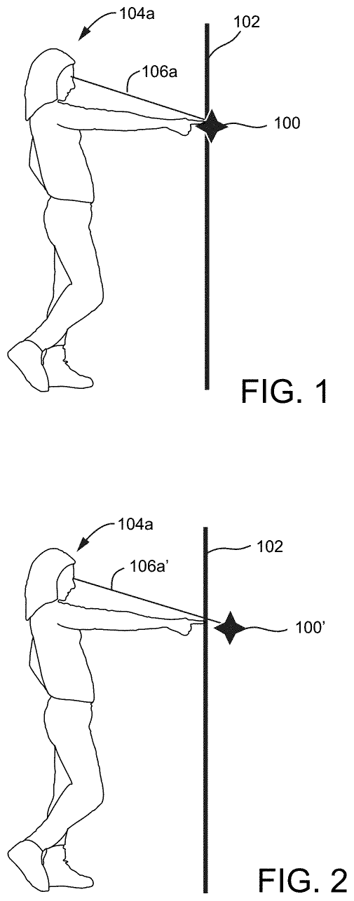

FIG. 2 schematically shows the case of an object of interest being located “behind”, “off of”, or spaced apart from, the back (non-user-facing) side of a touch panel;

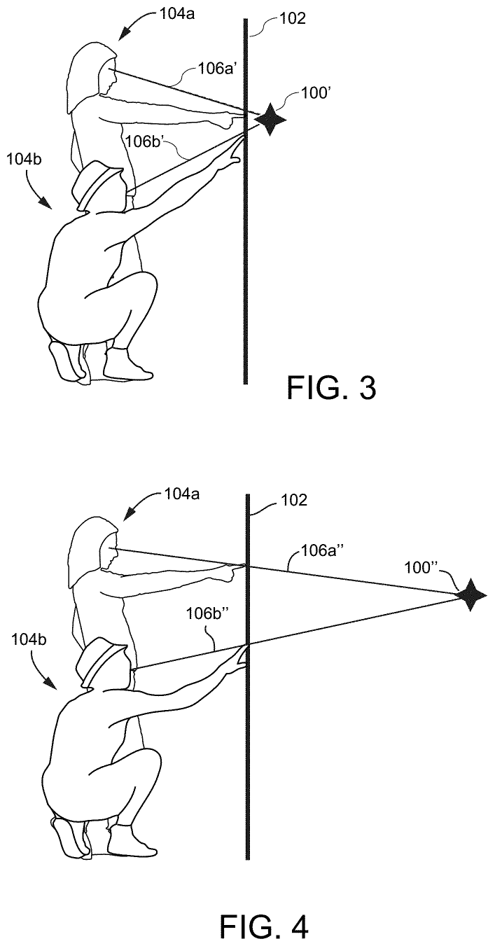

FIG. 3 schematically shows first and second human users with different viewing angles attempting to interact with the object of interest, which is located “behind”, “off of”, or spaced apart from, the back (non-user-facing) side of a touch panel;

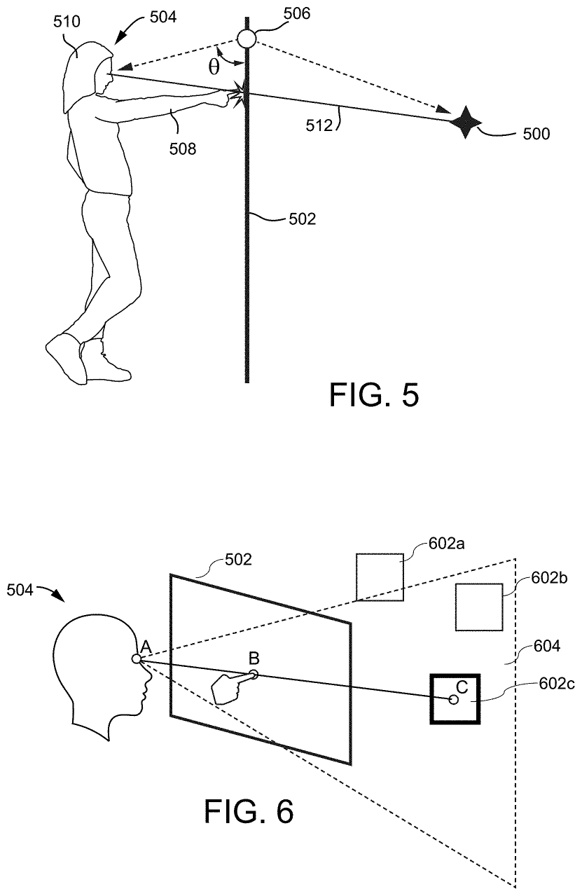

FIG. 4 schematically shows how the displacement problem of FIG. 3 is exacerbated as the object of interest moves farther and farther away from the touch panel;

FIGS. 5-6 schematically illustrate an approach for correcting for parallax, in accordance with certain example embodiments;

FIG. 7 a flowchart showing an approach for correcting for parallax that may be used in connection with certain example embodiments;

FIG. 8 shows “raw” images of a checkerboard pattern that may be used in connection with a calibration procedure of certain example embodiments;

FIG. 9A shows an example undistorted pattern;

FIG. 9B shows positive radial (barrel) distortion;

FIG. 9C shows negative radial (pincushion) distortion;

FIG. 10 is a representation of a histogram of oriented gradients for an example face;

FIG. 11 is a flowchart for locating user viewpoints in accordance with certain example embodiments;

FIG. 12 is an example glass configuration file that may be used in connection with certain example embodiments;

FIG. 13 is a block diagram showing hardware components that may be used in connection with touch drivers for parallax correction, in accordance with certain example embodiments;

FIG. 14 is a flowchart showing a process for use with touch drivers, in accordance with certain example embodiments;

FIG. 15 is a flowchart showing an example process for removing duplicate faces, which may be used in connection with certain example embodiments;

FIG. 16 is a flowchart showing how target identification may be performed in certain example embodiments;

FIG. 17 is a flowchart showing an example process that may take place when a tap is received, in accordance with certain example embodiments;

FIGS. 18A-18C are renderings of an example storefront, demonstrating how the technology of certain example embodiments can be incorporated therein;

FIG. 19 is a rendering of a display case, demonstrating how the technology of certain example embodiments can be incorporated therein;

FIGS. 20A-20F are renderings of an example custom museum exhibit, demonstrating how the technology of certain example embodiments can be incorporated therein; and

FIG. 21 schematically illustrates how a head-up display can be used in connection with certain example embodiments.

### DETAILED DESCRIPTION

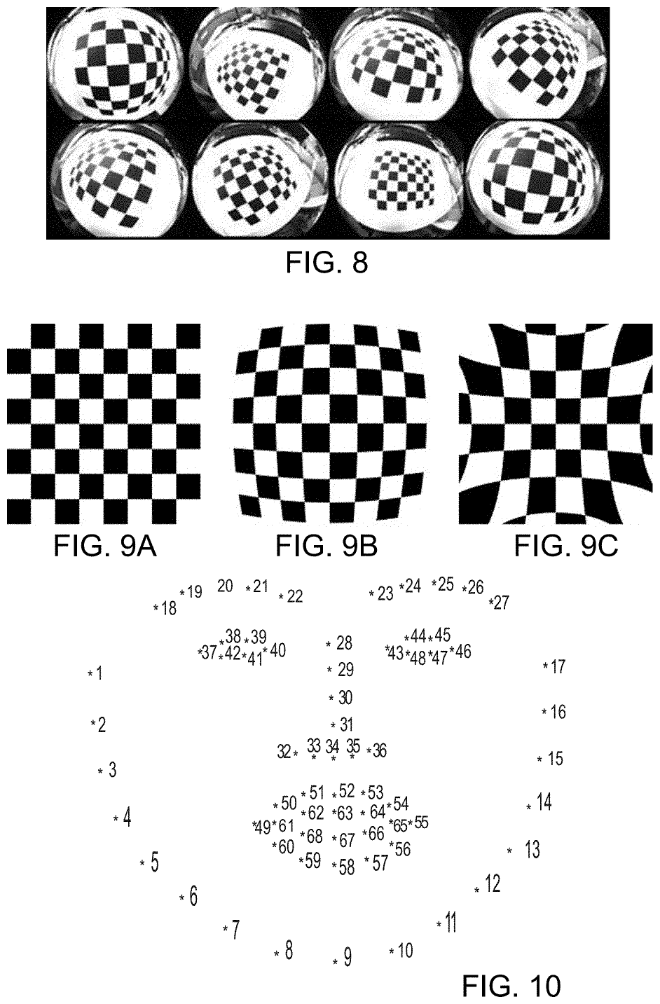

Certain example embodiments of this invention relate to dynamically determining perspective for parallax correction purposes, e.g., in situations where large area transparent touch interfaces and/or the like are implemented. These techniques advantageously make it possible for users to interact with one or more physical or virtual objects of interest “beyond” a transparent touch panel. FIG. 5 schematically illustrates an approach for correcting for parallax, in accordance with certain example embodiments. As shown in FIG. 5, one or more cameras 506 are provided to the touch panel 502, as the user 504 looks at the object of interest 500. The touch panel 502 is interposed between the object of interest 500 and the user 504. The camera(s) 506 has/have a wide field-of-view. For example, a single 360 degree field-of-view camera may be used in certain example embodiments, whereas different example embodiments may include separate user-facing and object-facing cameras that each have a broad field-of-view (e.g., 120-180 degrees). The camera(s) 506 has/have a view of both the user 504 in front of it/them, and the object of interest 500 behind it/them. Using image and/or video data obtained via the camera(s) 506, the user 504 is tracked. For example, user gestures 508, head/face position and/or orientation 510, gaze angle 512, and/or the like, can be determined from the image and/or video data obtained via the camera(s) 506. If there are multiple potential people interacting with the touch panel 502 (e.g., multiple people on the side of the touch panel 502 opposite the object of interest 500 who may or may not be interacting with the touch panel 502), a determination can be made to determine which one or more of those people is/are interacting with the touch panel 502. Based on the obtained gesture and/or gaze angle information, the perspective of the user 504 can be determined. This perspective information can be correlated with touch input information from the touch panel 502, e.g., to help compensate for parallax from the user's perspective and help ensure that an accurate touch detection is performed with respect to the object of interest 500.

Similar to FIG. 5, as shown schematically in FIG. 6, by leveraging computer vision software libraries and one or more cameras (e.g., USB webcams) to detect the location of a user's viewpoint (A) and a capacitive touch panel 502 to detect a point that has been touched by that user in real time (B), it becomes possible to identify a three-dimensional vector that passes through the touch panel 502 and towards any/all targets 602a-602c that are in the user's field of view 604. If this vector intersects a target (C), that target 602c is selected as the focus of a user's touch and appropriate feedback can be given. In certain example embodiments, the target search algorithm may be refactored to use an approach instead of, or together with, a lerping (linear interpolation) function to potentially provide better accuracy. For example, alternative or additional strategies may include implementation of a signed distance formula, only testing for known locations of objects of interest (e.g., instead of lerping out from the user, each object of interest is checked to see if it has been hit), etc.

As will be appreciated from the above, and as will become yet clearer from the more detailed description below, certain example embodiments are able to “see” the user and the content of interest, narrow the touch region and correlate between the user and the content, etc. In addition, the techniques of certain example embodiments are adaptable to a variety of content types such as, for example, staged still and/or moving images, real-life backgrounds, etc., while also being able to provide a variety of output types (such as, for example, audio, visual, projection, lighting (e.g., LED or other lighting), head-up display (HUD), separate display device (including dedicated display devices, user mobile devices, etc.), augmented reality system, haptic, and/or other output types) for possible use in a variety of different applications.

Although a flat, rectangular touch panel is shown schematically in various drawings, it will be appreciated that different touch panel shapes and orientations may be implemented in connection with different example embodiments. For instance, flat or curved touch panels may be used in certain example embodiments, and certain example embodiments may use other geometric shapes (which may be desirable for museum or other custom solutions in certain example embodiments). Setting up the geometry of the panels in advance and providing that information to the local controller via a configuration file may be useful in this regard. Scanning technology such as that provided by LightForm or similar may be used in certain example embodiments, e.g., to align the first panel to the projector, and then align every consecutive panel to that. This may aid in extremely easy in-field installation and calibration. For parallax adjustment, the projected pattern could be captured form two cameras, and a displacement of those cameras (and in turn the touch sensor) could be calculated.

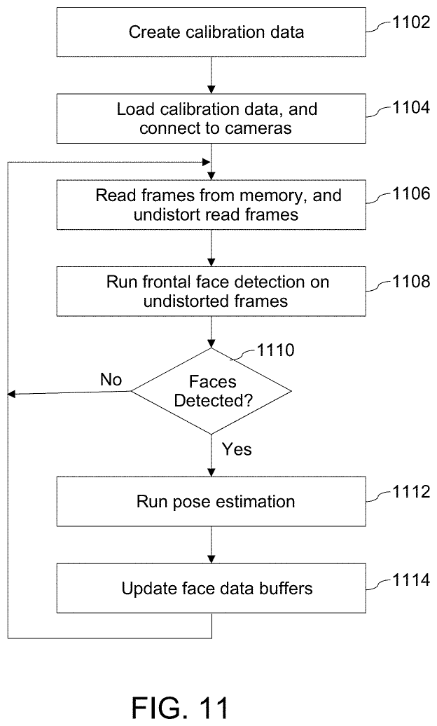

FIG. 7 is a flowchart showing an approach for correcting for parallax that may be used in connection with certain example embodiments. In step 702, image and/or video of a scene is obtained using a user-facing wide field-of-view camera, and/or from the user-facing side of a 360 degree camera or multiple cameras. In certain example embodiments, an array of “standard” (e.g., less than 360 degree) field of view cameras may be used. The desired field of view may be driven by factors such as the width of a production unit or module therein, and the number and types of cameras may be influenced by the desired field of view, at least in some instances. In step 704, rules are applied to determine which user likely is interacting with the touch panel. The user's viewing position on the obtained image's hemispherical projection is derived using face, eye, gesture, and/or other body-tracking software techniques in step 706. In step 708, image and/or video of a scene at which the user is looking is obtained using a target-facing wide field-of-view camera, and/or from the target-facing side of a 360 degree camera. In step 710, one or more object in the target scene are identified. For example, computer vision software may be used to identify objects dynamically, predetermined object locations may be read, etc. The user's position and the direction of sight obtained from the front-facing camera is correlated with the object(s) in the target scene obtained using the rear-facing camera in step 712. This information in step 714 is correlated with touch input from the touch panel to detect a “selection” or other operation taken with respect to the specific object the user was looking at, and appropriate output is generated in step 716. The FIG. 7 process may be selectively triggered in certain example embodiments. For example, the FIG. 7 process may be initiated in response to a proximity sensor detecting that a user has come into close relative proximity to (e.g., a predetermined distance of) the touch panel, upon a touch event being detected, based on a hover action, etc.

### Example Implementation

Details concerning an example implementation are provided below. It will be appreciated that this example implementation is provided to help demonstrate concepts of certain example embodiments, and aspects thereof are non-limiting in nature unless specifically claimed. For example, descriptions concerning example software libraries, image projection techniques, use cases, component configurations, etc., are non-limiting in nature unless specifically claimed.

### Example Techniques for Locating a User's Viewpoint

Computer vision related software libraries may be used to help determine a user's viewpoint and it's coordinates in three-dimensional space in certain example embodiments. Dlib and OpenCV, for example, may be used in this regard.

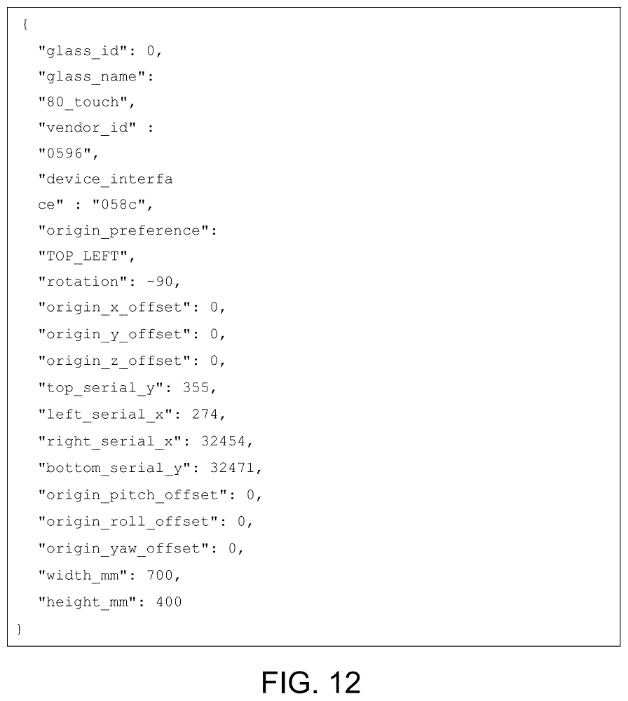

It may be desirable to calibrate cameras using images obtained therefrom. Calibration information may be used, for example, to “unwarp” lens distortions, measure the size and location of an object in real-world units in relation to the camera's viewpoint and field-of-view, etc. In certain example embodiments, a calibration procedure may involve capturing a series of checkerboard images with a camera and running them through OpenCV processes that provide distortion coefficients, intrinsic parameters, and extrinsic parameters of that camera. FIG. 8, for example, shows “raw” images of a checkerboard pattern that may be used in connection with a calibration procedure of certain example embodiments.

The distortion coefficients may be thought of as in some instances representing the radial distortion and tangential distortion coefficients of the camera, and optionally can be made to include thin prism distortion coefficients as well. The intrinsic parameters represent the optical center and focal length of the camera, whereas the extrinsic parameters represent the location of the camera in the 3D scene.

In some instances, the calibration procedure may be performed once per camera. It has been found, however, that it can take several calibration attempts before accurate data is collected. Data quality appears to have a positive correlation with capture resolution, amount of ambient light present, number of boards captured, variety of board positions, flatness and contrast of the checkerboard pattern, and stillness of the board during capture. It also has been found that, as the amount of distortion present in a lens drastically increases, the quality of this data seems to decrease. This behavior can make fisheye lenses more challenging to calibrate. Poor calibration results in poor undistortion, which eventually trickles down to poor face detection and pose estimation. Thus, calibration may be made to take place in conditions in which the above-described properties are positively taken into account, or under circumstances in which it is understood that multiple calibration operations may be desirable to obtain good data.

Once this calibration data is acquired, a camera should not require re-calibration unless the properties of that camera have been altered in a way that would distort the size/shape of the image it provides or the size/shape of the items contained within its images (e.g., as a result of changing lenses, focal length, capture resolution, etc.). Furthermore, calibration data obtained from one camera may be used to process images produced by a second camera of the same exact model, depending for example on how consistent the cameras are manufactured.

It will be appreciated that the calibration process can be optimized further to produce more accurate calibration files, which in turn could improve accuracy of viewpoint locations. Furthermore, in certain example embodiments, it may be possible to hardcode camera calibration files, in whole or in part, e.g., if highly-accurate data about the relevant properties of the camera and its lens can be obtained in advance. This may allow inaccuracies in the camera calibration process to be avoided, in whole or in part.

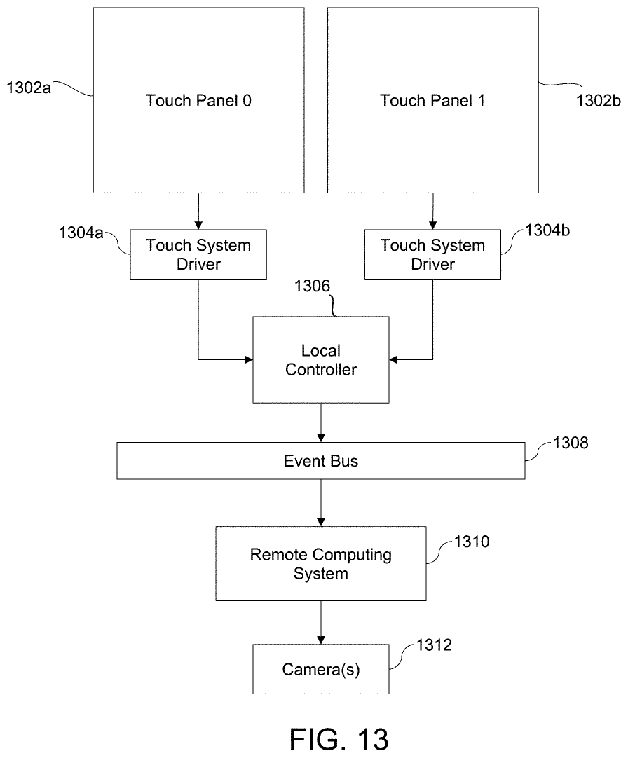

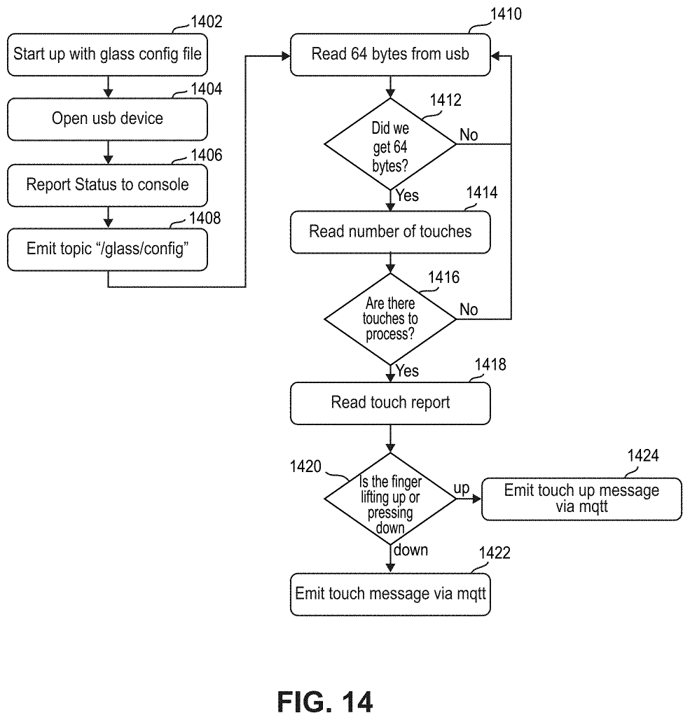

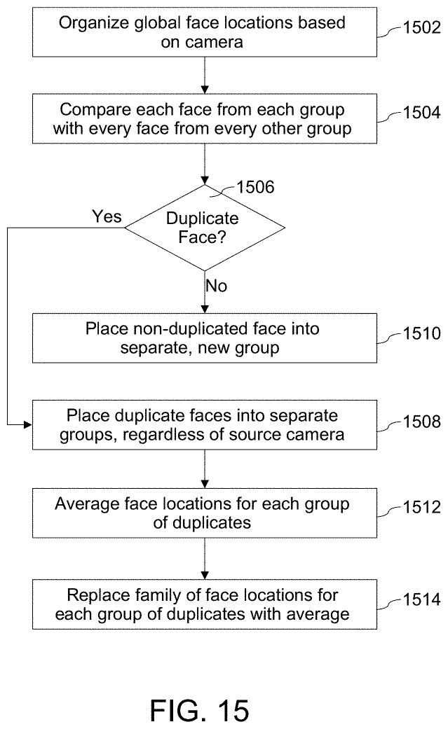

Calibration aids in gathering information about a camera's lens so that more accurate measurements can be made for “undistortion,” as well as other complex methods useful in certain example embodiments. With respect to undistortion, it is noted that FIG. 9A shows an example undistorted pattern, FIG. 9B shows positive radial (barrel) distortion, and FIG. 9C shows negative radial (pincushion) distortion. These distortions may be corrected for in certain example embodiments. For example, undistortion in certain example embodiments may involve applying the data collected during calibration to “un-distort” each image as it is produced. The undistortion algorithm of certain example embodiments tries to reconstruct the pixel data of the camera's images such that the image content appears as it would in the real world, or as it would appear if the camera had absolutely no distortion at all. Fisheye and/or non-fisheye cameras may be used in certain example embodiments, although it is understood that undistortion on images obtained from fisheye cameras sometimes will require more processing power than images produced by other camera types. In certain example embodiments, the undistortion will be performed regardless of the type of camera used prior to performing any face detection, pose estimation, or the like. The initUndistortRectifyMap( ) and remapo functions of OpenCV may be used in connection with certain example embodiments.

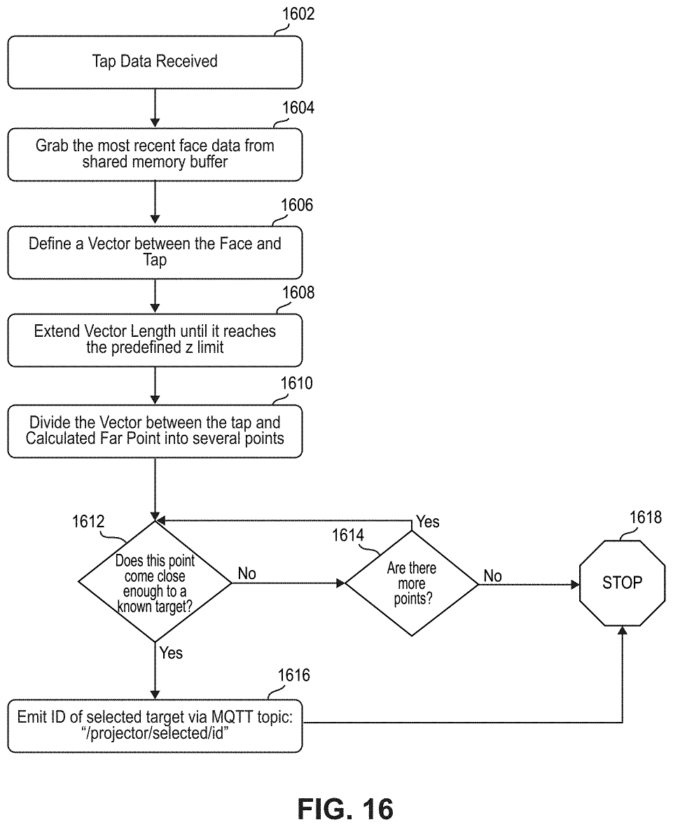

After establishing an “undistorted” source of images, it is possible to begin to detect faces in the images and/or video that the source provides. OpenCV may be used for this, but it has been found that Dlib's face detection tools are more accurate and provide fewer false positives. Certain example embodiments thus use Dlib in connection with face detection that uses a histogram of oriented gradients, or HOG, based approach. This means that an image is divided up into a grid of smaller portions, and the various directions in which visual gradients increase in magnitude in these portions are detected. The general idea behind the HOG approach is that it is possible to use the shape, size, and direction of shadows on an object to infer the shape and size of that object itself. From this gradient map, a series of points that represent the contours of objects can be derived, and those points can be matched against maps of points that represent known objects. The “known” object of certain example embodiments is a human face. FIG. 10 is a representation of a histogram of oriented gradients for an example face.

Different point face models may be used in different example embodiments. For example, a 68 point face model may be used in certain example embodiments. Although the 68 point model has an edge in terms of accuracy, it has been found that the use of a 5 point model may be used in certain example embodiments as it is much more performant. For example, the 5 point model may be helpful in keeping more resources available while processing multiple camera feeds at once. Both of these models work best when the front of a face is clearly visible in an image. Infrared (IR) illumination and/or an IR illuminated camera may be used to help assure that faces are illuminated and thus aid in front face imaging. IR illumination is advantageous because it is not disturbing to users and is advantageous for the overall system because it can help in capturing facial features which, in turn, can help improve accuracy. IR illumination may be useful in a variety of settings including, for example, low-light situations (typical of museums) and high lighting environments (e.g., where wash-out can occur).

Shape prediction algorithms of Dlib may be used in certain example embodiments to help improve accuracy. Camera positioning may be tailored for the specific application to aid in accurate face capture and feature detection. For instance, it has been found that many scenes involve people interacting with things below them, so having a lower camera can help capture data when looking down and when a head otherwise would be blocking face if imaged from above. In general, a camera may be placed to take into account where most interactions are likely to occur, which may be at or/above eye-level or, alternatively, below eye-level. In certain example embodiments, multiple cameras may be placed within a unit, e.g., to account for different height individuals, vertically spaced apart interaction areas, etc. In such situations, the image from the camera(s) that is/are less obstructed and/or provide more facial features may be used for face detection.

Face detection may be thought of as finding face landmark points in an image. Pose estimation, on the other hand, may be thought of as finding the difference in position between those landmark points detected during face detection, and static landmark points of a known face model. These differences can be used in conjunction with information about the camera itself (e.g., based on information previously collected during calibration) to estimate three-dimensional measurements from two-dimensional image points. This technical challenge is commonly referred to as Perspective-n-Point (or PnP), and OpenCV can be used to solve it in the context of certain example embodiments.

When capturing video, PnP can also be solved iteratively. This is performed in certain example embodiments by using the last known location of a face to aid in finding that face again in a new image. Though repeatedly running pose estimation on every new frame can carry a high performance cost, doing so may help provide more consistent and accurate measurements. For instance, spikes of highly inaccurate data are much rarer when solving iteratively.

When a camera is pointed at the side of someone's face, detection oftentimes is less likely to succeed. Anything that obscures the face (like facial hair, glasses, hats, etc.) can also make detection difficult. However, in certain example embodiments, a convolutional neural network (CNN) based approach to face pose estimation may be implemented to provide potentially better results for face profiles and in resolving other challenges. OpenPose running on a jetson tk2 can achieve frame rates of 15 fps for a full body pose, and a CNN-based approach may be run on this data. Alternatively, or in addition, a CNN-based approach can be run on a still image taken at time of touch.

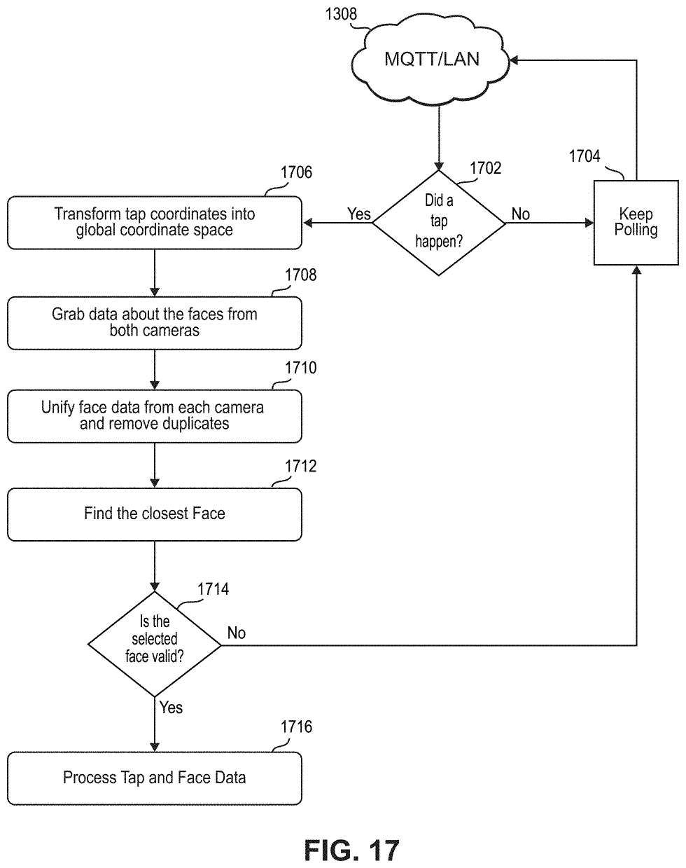

FIG. 11 is a flowchart for locating user viewpoints in accordance with certain example embodiments. In step 1102, for each camera to be used for computer vision, a module is run to create calibration data for that camera. As noted above, calibration could be automatic and potentially done beforehand (e.g., before installation, deployment, and/or activation) in certain example embodiments. For example, as noted above, it is possible to project a grid or other known geometric configuration and look for distortions in what is shown compared to what is expected. In certain example embodiments, a separate calibration file may be created for each camera. This calibration data creation operation need not be repeated for a given camera after that camera has been successfully calibrated (unless, for example, a characteristic of the camera changes by, e.g., replacement of a lens, etc.). In step 1104, relevant camera calibration data is loaded in a main application, and connections to those cameras are opened in their own processes to begin reading frames and copying them to a shared memory frame buffer. In step 1106, frames are obtained from the shared memory frame buffer and are undistorted using the calibration data for that camera. The fetching of frames and undistortion may be performed in its own processing thread in certain example embodiments. It is noted that multicore processing may be implemented in certain example embodiments, e.g., to help improve throughput, increase accuracy with constant throughput, etc.

The undistorted frames have frontal face detection performed on them in step 1108. In certain example embodiments, only the face shape that takes up the most area on screen is passed on. By only passing along the largest face, performance can be improved by avoiding the work of running pose estimation on every face. One possible downside to this strategy is that attention likely is given to the faces that are closest to cameras, and not the faces that are closest to the touch glass interface. This approach nonetheless may work well in certain example instances. In certain example embodiments, this approach of using only the largest face can be supplemented or replaced with a z-axis sorting or other algorithm later in the data processing in certain example embodiments, e.g., to help avoid some of these drawbacks. Image processing techniques for determining depth are known and may be used in different example embodiments. This may help determine the closest face to the camera, touch location, touch panel, and/or the like. Movement or body tracking may be used to aid in the determination of which of plural possible users interacted with the touch panel. That is, movement or body tracking can be used to determine, post hoc, the arm connected to the hand touching the touch panel, the body connected to that arm, and the head connected to that body, so that face tracking and/or the like can be performed as described herein. Body tracking includes head and/or face tracking, and gaze coordinates or the like may be inferred from body tracking in some instances.

If any faces are detected as determined in step 1110, data from that face detection is run though pose estimation, along with calibration data from the camera used, in step 1112. This provides translation vector (“tvec”) and rotation vector (“rvec”) coordinates for the detected face, with respect to the camera used. If a face has been located in the previous frame, that location can be leveraged to perform pose estimation iteratively in certain example embodiments, thereby providing more accurate results in some instances. If a face is lost, the tvec and rvec cached variables may be reset and the algorithm may start from scratch when another face is found. From these local face coordinates, it becomes possible to determine the local coordinates of a point that sits directly between the user's eyes. This point may be used as the user's viewpoint in certain example embodiments. Face data buffers in shared memory locations (e.g., one for each camera) are updated to reflect the most recent user face locations in their transformed coordinates in step 1114. It is noted that steps 1106-1110 may run continuously while the main application runs.

In certain example embodiments, the image and/or video acquisition may place content in a shared memory buffer as discussed above. The content may be, for example, still images, video files, individual frames extracted from video files, etc. The face detection and pose estimation operations discussed herein may be performed on content from the shared memory buffer, and output therefrom may be placed back into the shared memory buffer or a separate shared memory face data buffer, e.g., for further processing (e.g., for mapping processing tap coordinates with face coordinate information).

Certain example embodiments may seek to determine the dominant eye of a user. This may in some instances help improve the accuracy of their target selection by shifting their “viewpoint” towards, or completely to, that eye. In certain example embodiments, faces (and their viewpoints) are located purely through computer vision techniques. Accuracy may be improved in certain example embodiments by using stereoscopic cameras and/or infrared sensors to supplement or even replace pose estimation algorithms.

Example details concerning the face data buffer protocol and structure alluded to above will now be provided. In certain example embodiments, the face data buffer is a 17 element np.array that is located in a shared memory space. Position 0 in the 17 element array indicates whether the data is a valid face. If the data is invalid, meaning that there is not a detected face in this video stream, position 0 will be equal to 0. A 1 in this position on the other hand will indicate that there is a valid face. If the value is 0, the positional elements of this structure could also be 0, they simply could hold the last position a face was detected.

The remaining elements are data about the detected face's shape and position in relation to the scenes origin. The following table provides detail concerning the content of the array structure:

| Position | Description |
|---|---|
| 0 | 1 or 0 based on is the face is currently being observed |
| 1 | X translation from scene origin |
| 2 | Y translation from scene origin |
| 3 | Z translation from scene origin |
| 4 | X rotation of pose |
| 5 | Y rotation of pose |
| 6 | Z rotation of pose |
| 7 | Face Shape Point 0 X |
| 8 | Face Shape Point 0 Y |
| 9 | Face Shape Point 1 X |
| 10 | Face Shape Point 1 Y |
| 11 | Face Shape Point 2 X |
| 12 | Face Shape Point 2 Y |
| 13 | Face Shape Point 3 X |
| 14 | Face Shape Point 3 Y |
| 15 | Face Shape Point 4 X |
| 16 | Face Shape Point 4 Y |

To parse these values, they may be copied from the np.array to one or more other np.arrays that is/are the proper shape(s). The python object “face.py”, for example, may perform does the copying and reshaping. The tvec and rvec arrays each may be 3×1 arrays, and the 2D face shape array may be a 5×2 array.

As alluded to above, body tracking may be used in certain example embodiments. Switching to a commercial computer vision framework with built-in body tracking (like OpenPose, which also has GPU support) may provide added stability to user location detection by allowing users to be detected from a wider variety of angles. Body tracking can also allow for multiple users to engage with the touch panel at once, as it can facilitate the correlation of fingers in the proximity of touch points to user heads (and ultimately viewpoints) connected to the same “skeleton.”

### Example Techniques for Locating a User's Touchpoint

A variety of touch sensing technologies may be used in connection with different example embodiments. This includes, for example, capacitive touch sensing, which tend to be very quick to respond to touch inputs in a stable and accurate manner. Using more accurate touch panels, with allowance for multiple touch inputs at once, advantageously opens up the possibility of using standard or other touch screen gestures to control parallax hardware.

An example was built, with program logic related to recognizing, translating, and posting localized touch data being run in its own environment on a Raspberry Pi 3 running Raspian Stretch Lite (kernel version 4.14). In this example, two touch sensors were included, namely, 80 and 20 touch variants. Each sensor had its own controller. A 3M Touch Systems 98-1100-0579-4 controller was provided for the 20 touch sensor, and a 3M Touch Systems 98-1100-0851-7 controller was provided for the 80 touch sensor. A driver written in Python was used to initialize and read data from these controllers. The same Python code was used on each controller.

A touch panel message broker based on a publish/subscribe model, or a variant thereof, implemented in connection with a message bus, may be used to help distribute touch-related events to control logic. In the example, the Pi 3 ran an open source MQTT broker called mosquitto as a background service. This publish/subscribe service was used as a message bus between the touch panels and applications that wanted to know the current status thereof. Messages on the bus were split into topics, which could be used to identify exactly which panel was broadcasting what data for what purpose. Individual drivers were used to facilitate communication with the different touch controllers used, and these drivers implemented a client that connected to the broker.

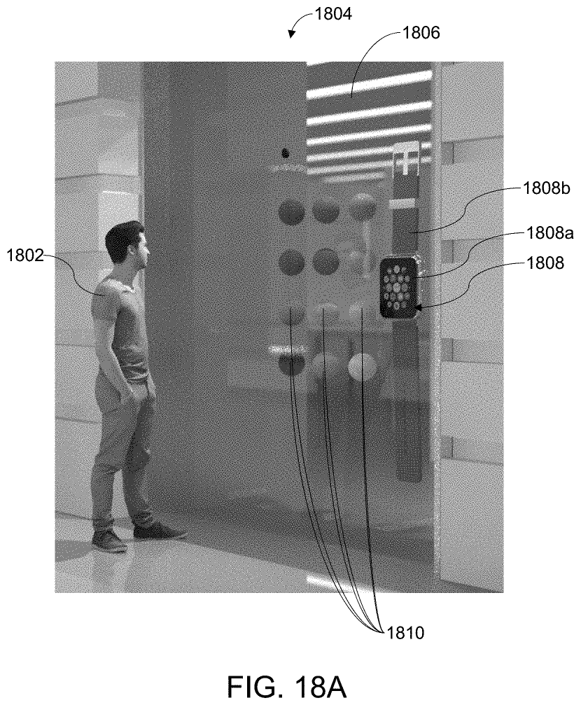

A glass configuration file may define aspects of the sensors such as, for example, USB address, dimensions, position in the scene, etc. See the example file below for particulars. The configuration file may be sent to any client subscribed to the ‘/glass/config’ MQTT topic. It may be emitted on the bus when the driver has started up and when request is published to the topic ‘/glass/config/get’. FIG. 12 is an example glass configuration file that may be used in connection with certain example embodiments.

The following table provides a list of MQTT topics related to the touch sensors that may be emitted to the bus in certain example embodiments:

| | |
|---|---|
| /glass/tap | Emitted when a finger comes in contact |
| /glass/touch | Continuously emitted when a finger is in contact |
| /glass/touch/up | Emitted when a finger removes contact |
| /glass/config | Emits the glass's configuration file as json |
| /glass/config/get | Any message published to this topic will cause all |
| | glass MQTT clients to emit their configurations on |
| | the /glass/config topic |

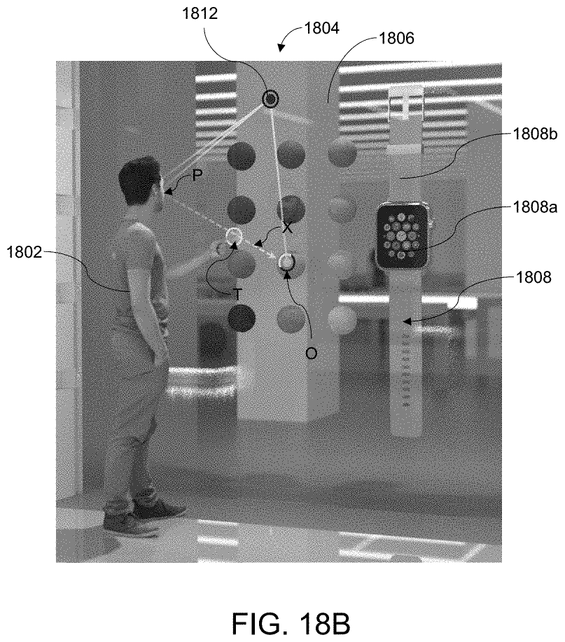

Based on the above, FIG. 13 is a block diagram showing hardware components that may be used in connection with touch drivers for parallax correction, in accordance with certain example embodiments. FIG. 13 shows first and second transparent touch panels 1302a, 1302b, which are respectively connected to the first and second system drivers 1304a, 1304b by ZIF controllers. The first and second system drivers 1304a, 1304b are, in turn, connected to the local controller 1306 via USB connections. The local controller 1306 receives data from the control drivers 1304a, 1304b based on interactions with the touch panels 1302a, 1302b and emits corresponding events to the event bus 1308 (e.g., on the topics set forth above). The events published to the event bus 1308 may be selectively received (e.g., in accordance with a publish/subscribe model or variant thereof) at a remote computing system 1310. That remote computing system 1310 may including processing resources such as, for example, at least one processor and a memory, that are configured to receive the events and generate relevant output based on the received events. For instance, the processing resources of the remote computing system 1310 may generate audio, video, and/or other feedback based on the touch input. One or more cameras 1312 may be connected to the remote computing system 1310, as set forth above. In certain example embodiments, the local controller 1306 may communicate with the event bus 1308 via a network connection.

It will be appreciated that more or fewer touch panels may be used in different example embodiments. It also will be appreciated that the same or different interfaces, connections, and the like, may be used in different example embodiments. In certain example embodiments, the local controller may perform operations described above as being handled by the remote computing system, and vice versa. In certain example embodiments, one of the local controller and remote computing system may be omitted.

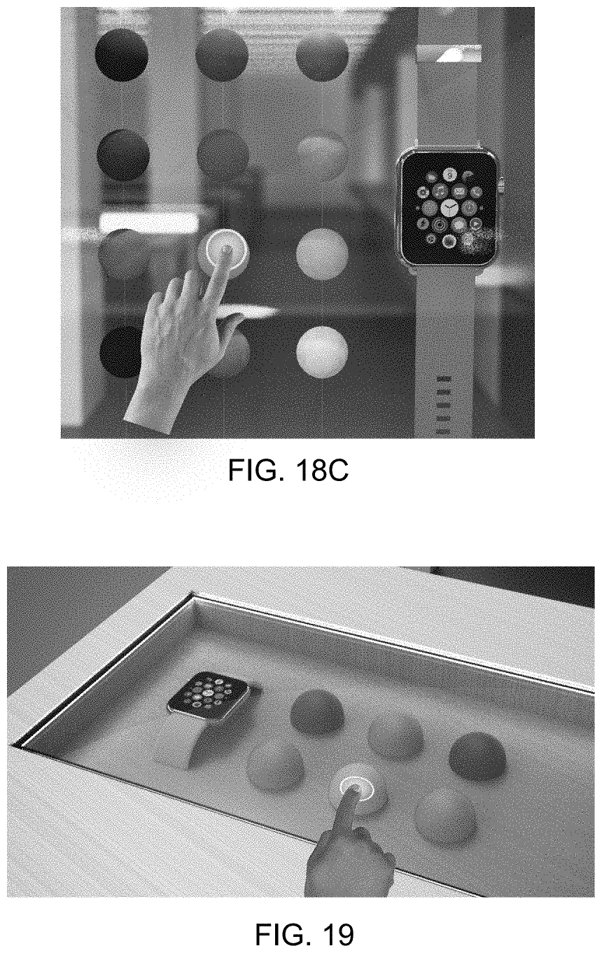

FIG. 14 is a flowchart showing a process for use with touch drivers, in accordance with certain example embodiments. Startup begins with processes related to a touch panel configuration file, as indicated in step 1402. The local controller opens a USB or other appropriate connection to the touch panel drivers in step 1404. The touch panel drivers send reports on their respective statuses to the local controller in step 1406. This status information may indicate that the associated touch panel is connected, powered, ready to transmit touch information, etc. When one of the touch panel drivers begins running, it emits glass configuration data relevant to the panel that it manages over the MQTT broker, as shown in step 1408. This message alerts the main application that a “new” touch panel is ready for use and also defines the shape and orientation of the glass panel in the context of the scene it belongs to. Unless this data is specifically asked for again (e.g., by the main application running on the local controller), it is only sent once.

The drivers read data from the touch panels in step 1410. Data typically is output in chunks and thus may be read in chunks of a predetermined size. In certain example embodiments, and as indicated in step 1410 in FIG. 14, 64 byte chunks may be read. In this regard, the example system upon which FIGS. 13-14 are based includes touch sensors on the touch panels that each can register and output data for 10 touches at a time. It will be appreciated that more data may need to be read if there is a desire to read more touches at a single time. Regardless of what the chunk size is, step 1412 makes sure that each chunk is properly read in accordance with the predetermined size, prompting the drivers to read more data when appropriate.

The touches are read by the driver in step 1414. If there are more touches to read as determined in step 1416, then the process returns to step 1410. Otherwise, touch reports are generated. That is, when a touch is physically placed onto a touch panel, its driver emits a touch message or touch report with the local coordinates of the touch translated to an appropriate unit (e.g., millimeters). This message also includes a timestamp of when the touch happened, the status of the touch (down, in this case), and the unique identifier of the touched panel. An identical “tap” message is also sent at this time, which can be subscribed to separately from the aforementioned “touch” messages. Subscribing to tap messages may be considered if there is a desire to track a finger landing upon the panel as opposed to any dragging or other motions across the panel. As a touch physically moves across the touch panel it was set upon, the driver continues to emit “down” touch messages, with the same data format as the original down touch message. When a touch is finally lifted from the touch panel, another touch message is sent with the same data format as the previous touch messages, except with an “up” status. Any time a new touch happens, the operations are repeated. Otherwise, the driver simply runs waiting for an event.

This procedure involves the local controller reading touch reports in step 1418. A determination as to the type of touch report is made in step 1420. Touch down events result in a suitable event being emitted to the event bus in step 1422, and touch up events result in a suitable event being emitted to the event bus in step 1424. Although the example discussed above relates to touch/tap events, it will be appreciated that the techniques described herein may be configured to detect commonly used touch gestures such as, for example, swipe, slide, pinch, resize, rubbing, and/or other operations. Such touch gestures may in some instances provide for a more engaging user experience, and/or allow for a wider variety of user actions (e.g., in scenes that include a small number of targets).

### Example Techniques for Locating Selectable Targets

Through computer vision techniques similar to those used for face detection, it is possible to track targets in real time as they move about in a scene being imaged. It will be appreciated that if all selectable targets in a scene are static, however, there is no need for this real-time tracking. For example, known targets may be mapped before the main application runs. By placing ArUco or other markers at the center or other location of each target of a given scene, it is possible to use computer vision to estimate the central or other location of that target. By tying the locational data of each target to a unique identifier and a radius or major distance value, for example, the space that each specific target occupies may be mapped within a local coordinate system. After this data is collected, it can be saved to a file that can be later used in a variety of scenes. In certain example embodiments, the markers may be individually and independently movable, e.g., with or without the objects to which they are associated. Target mapping thus can take place dynamically or statically in certain example embodiments.

The space that any target occupies may be represented by a sphere in certain example embodiments. However, other standard geometries may be used in different example embodiments. For example, by identifying and storing the actual geometry of a given target, the space that it occupies can be more accurately represented, potentially aiding in more accurate target selection.

In some instances, a target cannot be moved, so an ArUco or other marker may be placed on the outside of this target and reported data may be manually corrected to find that target's true center or other reference location. However, in certain example embodiments, by training a target model that can be used to detect the target itself instead of using an ArUco or other marker, it may be possible to obtain more accurate target location and reduce human error introduced by manually placing and centering ArUco or other markers at target locations. This target model advantageously can eliminate the need to apply ArUco or other markers to the targets that it represents in some instances. In certain example embodiments, objects' locations may be defined as two-dimensional projections of the outlines of the objects, thereby opening up other image processing routines for determining intersections with a calculated vector between the user's perspective and the touch location in some instances. Additionally, or alternatively, objects may be defines as a common 2D-projected shape (e.g., a circle, square, or rectangle, etc.), 3D shape (e.g., a sphere, square, rectangular prism, etc.), or the like. Regardless of whether a common shape, outline, or other tagging approach is used, the representation of the object may in certain example embodiments be a weighted gradient emanating from the center of the object. Using a gradient approach may be advantageous in certain example embodiments, e.g., to help determine which object likely is selected based on the gradients as between proximate objects. For example, in the case of proximate or overlapping objects of interest, a determination may be made as to which of plural gradients are implicated by an interaction, determining the weights of those respective gradients, and deeming the object having to the higher-weighted gradient to be the object of interest being selected. Other techniques for determining the objects of interest may be used in different example embodiments.

Target mapping with computer vision can encounter difficulties similar to those explained above in connection with face tracking. Thus, similar improvements can be leveraged to improve target mapping in certain example embodiments. For instance, by using stereoscopic cameras and/or infrared sensors, optimizing the camera calibration process, hardcoding camera calibration data, etc., it becomes possible to increase the accuracy of the collected target locations.

### Example Scene Management Techniques

Unless all components of a scene are observable in a global coordinate space, it may not be possible to know the relationships between those components. The techniques discussed above for collecting locational data for faces, touches, and targets do so in local coordinate spaces. When computer vision is involved, as with face and target locations, the origin of that local coordinate space typically is considered to be at the optical center of the camera used. When a touch panel is involved, as with touch locations, the origin of that local coordinate space typically is considered to be at the upper left corner of the touch panel used. By measuring the physical differences between the origin points on these devices and a predetermined global origin point, it becomes possible to collect enough information to transform any provided local coordinate to a global coordinate space. These transformations may be performed at runtime using standard three-dimensional geometric translation and rotation algorithms.

Because each touch panel reports individual touches that have been applied to it, and not touches that have been applied to other panels, the touch interface in general does not report duplicate touch points from separate sources. However, the same cannot be said for locations reported by a multi-camera computer vision process. Because it is possible, and oftentimes desirable, for there to be some overlap in camera fields-of-view, it is also possible that one object may be detected several times in separate images that have each been provided by a separate camera. For this reason, it may be desirable to remove duplicate users from the pool of face location data.

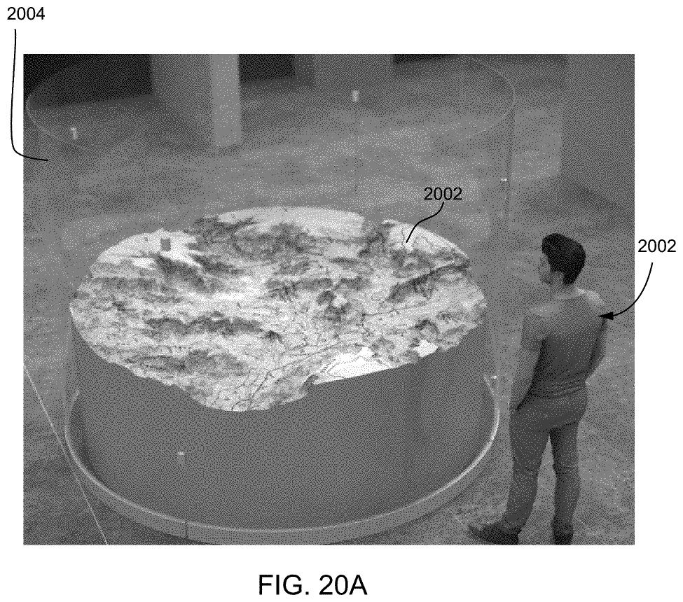

FIG. 15 is a flowchart showing an example process for removing duplicate faces, which may be used in connection with certain example embodiments. In step 1502, currently known global face locations are organized into groups based upon the camera feed from which they were sourced. In step 1504, each face from each group is compared with every face from the groups that face is not in, e.g., to determine if it has any duplicates within that group. This may be performed by treating faces whose center or other defined points are not within a predefined proximity (e.g., 300 mm) to each other as non-duplicates. In certain example embodiments, a face location is only considered to be a duplicate of a face location from another group if no other face from that other group is closer to it. It will be appreciated that faces within a group need not be compared to one another, because each face derived from the same camera source reliability can be considered to represent a different face (and therefore a different user).

In step 1506, a determination is made as to whether the face is a duplicate. Duplicate faces are placed into new groups together, regardless of which camera they come from, in step 1508. As more duplicates are discovered, they are placed into the same group as their other duplicates. Faces without duplicates are placed into their own new groups in step 1510. Each new group should now represent the known location, or locations, of each individual user's face.

Each group of duplicate face locations is averaged in step 1512. In step 1514, each average face location replaces the group of location values that it was derived from, as the single source for a user's face location. As a result, there should be a single list of known user face locations that matches the amount of users currently being captured by any camera.

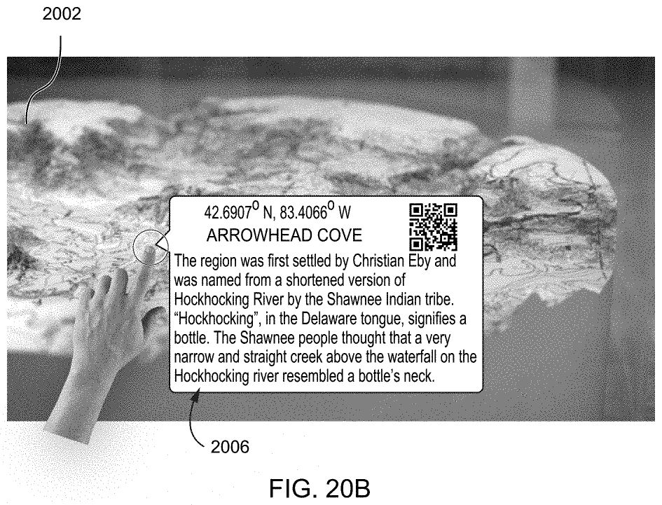

In certain example embodiments, when a user taps the touch interface, an inventory of all known global locations in the current scene (e.g., user faces, touches, and targets) is taken. The relationships of these separate components are then analyzed to see if a selection has been made. In this regard, FIG. 16 is a flowchart showing how target identification may be performed in certain example embodiments. Tap data is received in step 1602. The most recent face data from the shared memory buffer is obtained in step 1604.

A three-dimensional vector/line that starts at the closest user's viewpoint and ends at the current touchpoint or current tap location is defined in step 1606. That vector or line is extended “through” the touch interface towards an end point that is reasonably beyond any targets in step 1608. The distance may be a predefined limit based on (e.g., 50% beyond, twice as far as, etc.), for example, the z-coordinate of the farthest known target location. In step 1610, linear interpolation is used to find a dense series of points that lie on the portion of the line that extends beyond the touch interface.

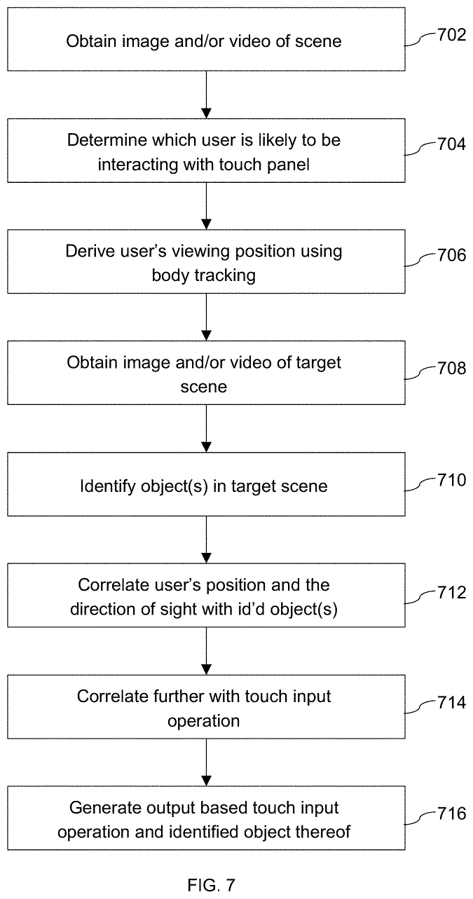

One at a time, from the touch interface outward (or in some other predefined order), it is determined in step 1612 whether any of these interpolated points sit within the occupied space of each known target. Because the space each target occupies is currently represented by a sphere, the check may involve simply determining whether the distance from the center of a given target to an interpolated point is less than the known radius of that target. The process repeats while there are more points to check, as indicated in step 1614. For instance, as will be appreciated from the description herein, each object of interest with which a user may interact sits in a common coordinate system, and a determination may be made as to whether one of the locations in the common coordinate system comes within a threshold distance of a virtual line extending from the gaze coordinates in the common coordinate system through and beyond the touch coordinates in the common coordinate system. See, for example, gaze angle 106a″ intersecting object 100″ in FIG. 4, gaze angle 512 intersecting object 500 in FIG. 5, and points A-C and target 602c in FIG. 6, as well as the corresponding descriptions.

Once it is determined that one of these interpolated points is within a given target, that target is deemed to be selected, and information is emitted on the event bus in step 1616. For example, the ID of the selected target may be emitted via an MQTT topic “/projector/selected/id”. Target and point for intersection analysis stops, as indicated in step 1618. If every point is analyzed without finding a single target intersection, no target is selected, and the user's tap is considered to have missed. Here again, target and point for intersection analysis stops, as indicated in step 1618. Certain example embodiments may consider a target to be touched if it is within a predetermined distance of the vector or the like. In other words, some tolerance may be allowed in certain example embodiments.

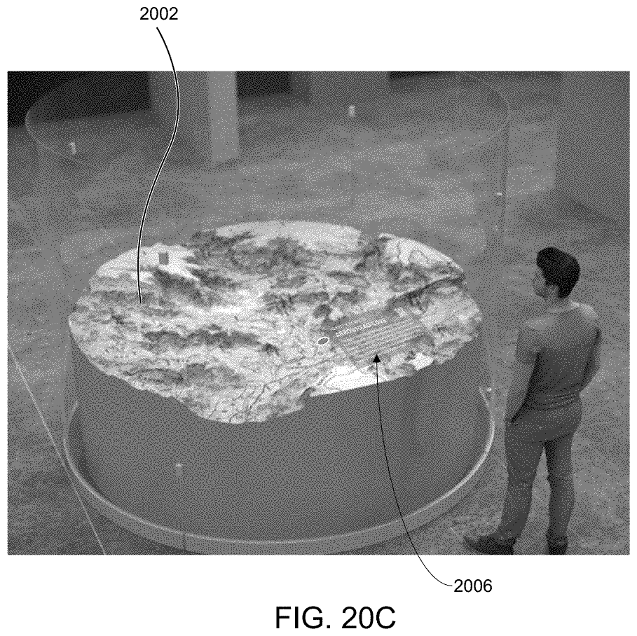

FIG. 17 is a flowchart showing an example process that may take place when a tap is received, in accordance with certain example embodiments. The main application, responsible for scene management, pulls in all configuration information it needs for the camera(s) and touch panels, and initializes the processes that continuously collect the local data they provide. That information is output to the event bus 1308. A determination is made as to whether a tap or other touch-relevant event occurs in step 1702. If not, then the application continues to wait for relevant events to be emitted onto the event bus 1308, as indicated in step 1704. If so, local data is transformed to the global coordinate space, e.g., as it is being collected in the main application, in step 1706. Measurements between local origin points and the global origin point may be recorded in JSON or other structured files. However, in certain example embodiments, a hardware configuration wizard may be run after camera calibration and before the main application runs to aid in this process.

After global transformation, face data is obtained in step 1708, and it is unified and duplicate data is eliminated as indicated in step 1710. See FIG. 15 and the associated description in this regard. The closest face is identified in step 1712, and it is determined whether the selected face is valid in step 1714. If no valid face is found, the process continues to wait, as indicated in step 1704. If a valid face is found, however, the tap and face data is processed in step 1716. That is, target selection is performed via linear interpolation, as explained above in connection with FIG. 16. If a target is selected, the user is provided with the appropriate feedback. The process then may wait for further input, e.g., by returning to step 1704.

It will be appreciated that the approach of using interpolated points to detect whether a target has been selected may in some instances leave some blind spots between said points. It is possible that target intersections of the line could be missed in these blind spots. This issue can be avoided by checking the entire line (instead of just points along it) for target intersection. Because targets are currently represented by spheres, standard line-sphere intersection may be leveraged in certain example embodiments to help address this issue. This approach may also prove to be more performant in certain example instances, as it may result in fewer mathematical checks per tap. Another way to avoid the blind spot issue, may involve using ray-sphere intersection. This technique may be advantageous because there would be no need to set a line end-point beyond the depth of the targets. These techniques may be used in place of, or together with, the linear interpolation techniques set forth above.

Certain example embodiments may project a cursor for calibration and/or confirmation of selection purposes. In certain example embodiments, a cursor may be displayed after a selection is made, and a user may manually move it, in order to confirm a selection, provide initial calibration and/or training for object detection, and/or the like.

### Example Storefront Use Case

The technology disclosed herein may be used in connection with a storefront in certain example embodiments. The storefront may be a large format, panelized and potentially wall-height unit in some instances. The touch panel may be connected to or otherwise build into an insulated glass (IG) unit. An IG unit typically includes first and second substantially parallel substrates (e.g., glass substrates) separated from one another via a spacer system provided around peripheral edges of the substrates. The gap or cavity between the substrates may be filled with an inert gas (such as, for example, argon, krypton, xenon) and/or oxygen. In certain example embodiments, the transparent touch panel may take the place of one of the substrates. In other example embodiments, the transparent touch panel may be laminated or otherwise connected to one of the substrates. In still another example, the transparent touch panel may be spaced apart from one of the substrates, e.g., forming in effect a triple (or other) IG unit. The transparent touch panel may be the outermost substrate and oriented outside of the store or other venue, e.g., so that passersby have a chance to interact with it.

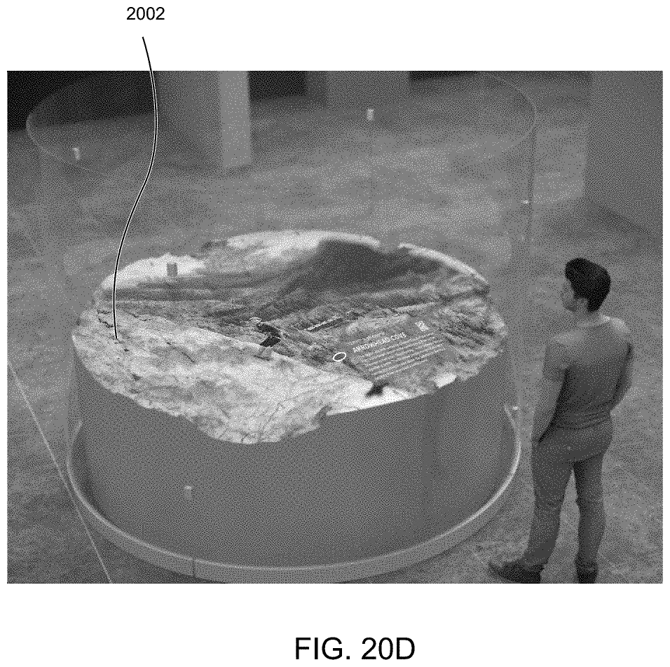

FIGS. 18A-18C are renderings of an example storefront, demonstrating how the technology of certain example embodiments can be incorporated therein. As shown in FIG. 18, a user 1802 approaches a storefront 1804, which has a transparent display 1806. The transparent display 1806 appears to be a “normal” window, with a watch 1808 and several differently colored/materialed swatches options 1810 behind it. The watch 1808 includes a face 1808a and a band 1808b. The watch 1808 and/or the swatches 1810 may be real or virtual objects in different instances. The swatches are sphere shaped in this example but other sizes, shapes, textures, and/or the like may be used in different example embodiments.

The user 1802 is able to interact with the storefront 1804, which is now dynamic rather than being static. In some instances, user interaction can be encouraged implicitly or explicitly (e.g., by having messages displayed on a display, etc.). The interaction in this instance involves the user 1802 being able to select one of the color swatches 1810 to cause the watch band 1808b to change colors. The interaction thus happens “transparently” using the real or virtual objects. In this case, the coloration is not provided in registration with the touched object but instead is provided in registration with a separate target. Different example embodiments may provide the coloration in registration with the touched object (e.g., as a form of highlighting, to indicate a changed appearance or selection, etc.).

In FIG. 18B, the calibrated camera 1812 sees the user 1802 as well as the objects behind the transparent display 1806 (which in this case is the array of watch band colors and/or materials). The user 1802 simply points on the transparent display 1806 at the color swatch corresponding to the band color to be displayed. The system determines which color is selected and changes the color of the watch band 1808b accordingly. As shown in FIG. 18B, for example, the touch position T and viewpoint P are determined. The extension of the line X passing from the viewpoint P through the touch position T is calculated and determined to intersect with object O.

The color of the watch band 1808b may be changed, for example, by altering a projection-mapped mockup. That is, a physical product corresponding to the watch band 1808b may exist behind the transparent display 1806 in certain example embodiments. A projector or other lighting source may selectively illuminate it based on the color selected by the user 1802.

As will be appreciated from FIG. 18C, through the user's eyes, the experience is as seamless and intuitive as looking through a window. The user merely touches on the glass at the desired object, then the result is provided. Drag, drop, and multi-touch gestures are also possible, e.g., depending on the designed interface. For instance, a user can drag a color to the watch band and drop it there to trigger a color change.

Although the example shown in and described in connection with FIGS. 18A-18C involves a large projection-mapped physical article, it will be appreciated that other output types may be provided. For example, an updatable display may be provided on a more conventional display device (e.g., a flat panel display such as, for example, an LCD device or the like), by being projected onto the glass (e.g., as a head-up display or the like), etc. In certain example embodiments, the display device may be a mobile device of the user's (e.g., a smart phone, tablet, or other device). The user's mobile device may synch with a control system via Bluetooth, Wi-Fi, NFC, and/or other communication protocols. A custom webpage for the interaction may be generated and displayed for the user in some instances. In other instances, a separate app running on the mobile device may be activated when in proximity to the storefront and then activated and updated based on the interactions.

Similarly, this approach may be used in connection free-standing glass wall at an in-store display (e.g., in front of a manikin stand at the corner of the clothing and shoe sections) or in an open-air display.

### Example Display Case Use Case

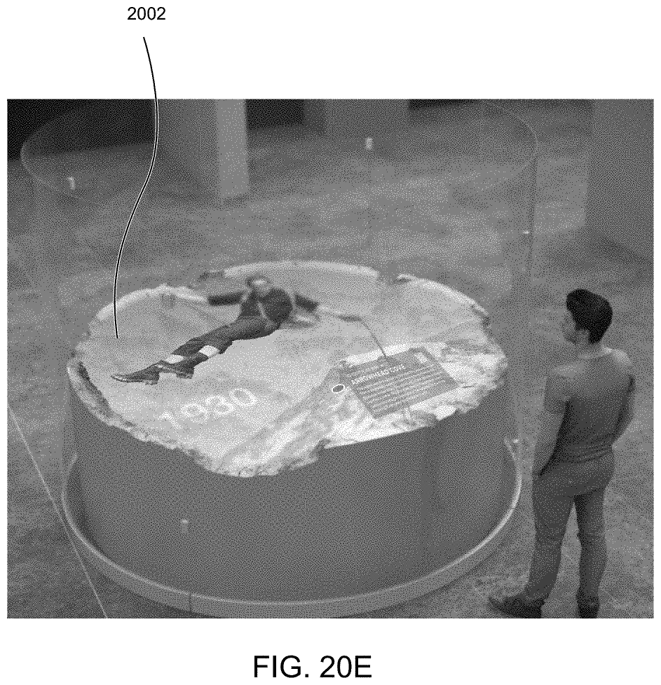

The same or similar technology as that described above in connection with the example storefront use case may be used in display cases, e.g., in retail and/or other establishments. Display cases may be window-sized standard units or the like. FIG. 19 is a rendering of a display case, demonstrating how the technology of certain example embodiments can be incorporated therein. The FIG. 19 example is related to the example discussed above in connection with FIGS. 18A-18C and may function similarly.

In certain example embodiments, the display case may be an freezer or refrigerator at a grocery store or the like, e.g., where, to conserve energy and provide for a more interesting experience, the customer does not open the cooler door and instead simply touches the glass or other transparent medium to make a selection, causing the selected item (e.g., a pint of ice cream) to be delivered as if the merchandizer were a vending machine.

### Example Museum Use Cases

Museums oftentimes want visitors to stop touching their exhibits. Yet interactivity is still oftentimes desirable as a way to engage with visitors. The techniques of certain example embodiments may help address these concerns. For example, storefront-type displays, display case type displays, and/or the like can be constructed in manners similar to those discussed in the two immediately preceding use cases. In so doing, certain example embodiments can take advantage of people's natural tendency to want to touch while providing new experiences and revealing hidden depths of information.

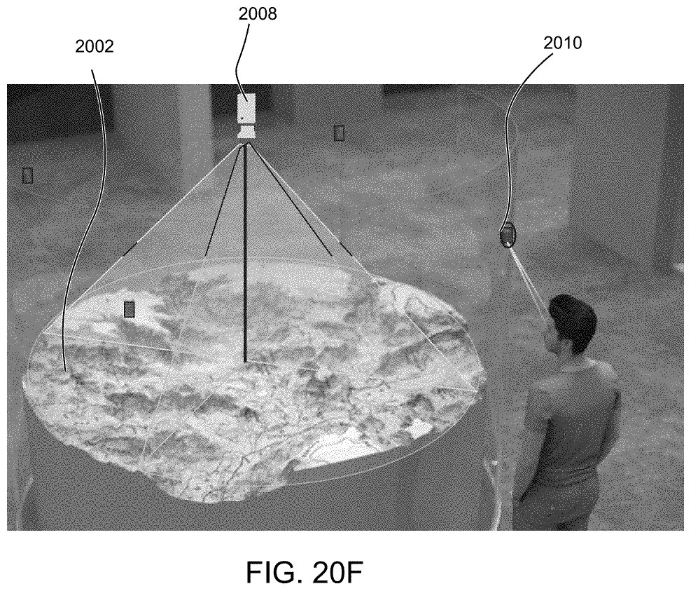

FIGS. 20A-20F are renderings of an example custom museum exhibit, demonstrating how the technology of certain example embodiments can be incorporated therein. As shown in FIG. 20A, a user 2000 interacts with a large physical topography 2002, which is located behind a glass or other transparent enclosure 2004. The transparent enclosure 2004 serves a touch panel and at least partially encloses the exhibit in this example, tracking user touches and/or other interactions. For instance, as the user 2000 discovers locations of interest, the user 2000 just points at them, and the topography 2002 and/or portions thereof change(s) to present more or different information. In certain example embodiments, the colors of the physical topography 2002 may be projected onto the model lying thereunder.

As shown in FIG. 20B, when the user touches a location on the map, a display area 2006 with further information may be provided. The display area may be projected onto the topography 2002, shown on the enclosure 2004 (e.g., in a head-up display area), displayed via a separate display device connected to exhibit, displayed via mobile device of the user (e.g., running on a museum or other branded app, for example), shown on a dedicated piece of hardware given to the visitor, etc.

In certain example embodiments, the position of the display area 2006 may be determined dynamically. For instance, visual output tailored for the touched object may be projected onto an area of the at least one transparent touch panel that, when viewed from the gaze coordinates, does not overlap with the objects of interest, appears to be superimposed on the touched object (e.g., from the touching user's perspective), appears to be adjacent to, but not superimposed on, the touched object (e.g., from the touching user's perspective), etc. In certain example embodiments, the position of the display area 2006 may be a dedicated area. In certain example embodiments, multiple display areas may be provided for multiple users, and the locations of those display areas may be selected dynamically so as to be visible to the selecting users without obscuring the other user(s).

The determination of what to show in the display area 2006 may be performed based on a determination of what object is being selected. In this regard, the viewpoint of the user and the location of the touch point are determined, and a line passing therethrough is calculated. If that line intersects any pre-identified objects on the topography 2002, then that object is determined to be selected. Based on the selection, a lookup of the content to be displayed in the display area 2006 may be performed, and the content itself may be retrieved for a suitable computer readable storage medium. The dynamic physical/digital projection can be designed to provide a wide variety of multimedia content such as, for example, text, audio, video, vivid augmented reality experiences, etc. AR experiences in this regard do not necessarily need users to wear bulky headsets, learn how to use complicated controllers, etc.

The display area 2006 in FIG. 20B may include a QR or other code, enabling the user to obtain more information about a portion of the exhibit using a mobile device or the like. In certain example embodiments, the display area 2006 itself may be the subject of interactions. For example, a user may use pan gestures to scroll up or down to see additional content (e.g., read more text, see further pictures, etc.). In certain example embodiments, these projected display areas 2006, and/or areas therein (e.g., scroll bars or the like and user interface elements in general) may be treated as objects of interest that the user can interact with. In that regard, the system can implement selective or layers objects, such that the display area 2006 is treated as a sort of sub-object that will only be considered in the linear interpolation or the like if the user has first made a top-level selection. Multiple layers or nestings of this sort may be provided in different example embodiments. This approach may be applied in the museum exhibit and other contexts.

FIG. 20C shows how the display area 2006 can be provided on the topography itself. FIGS. 20D-20E show how the topography in whole or in part can be changed to reveal more information about the selection, e.g., while the display area 2006 is still displayed. The underlying physical model may be taken into account in the projecting to make it seem that the display is “flat” to a user.

FIG. 20F shows one or more projectors projecting the image onto the topography 2002. Projection mapping works as simply as a normal projector, but takes into account the shape and typography of the surface that is being projected onto. The result is very eye popping without the cost associated with transparent displays. Projection mapping is advantageously in that graphics are visible from many angles and not just one perspective. FIG. 20F also shows how a camera 2010 can be integrated into the display itself in certain example embodiments, e.g., to aid in touch and face detection for the overall system.

As indicated above, a wide variety of output devices may be used in different example embodiments. In the museum exhibit example use cases, and/or in other use cases, display types may include printed text panels with optional call out lights (as in classic museum-type exhibits), fixed off-model display devices, fixed-on model display devices, movable models and/or displays, animatronics, public audio, mobile/tablet private audio and/or video, etc.

Although a map example has been described, it will be appreciated that other example uses may take advantage of the technology disclosed herein. For example, a similar configuration could be used to show aspects of a car body and engine cross section, furniture and its assembly, related historic events, a workshop counter to point out tools and illustrate processes, animal sculptures to show outer pattern variety and interior organs, etc.

### Example Head-Up Display Use Case

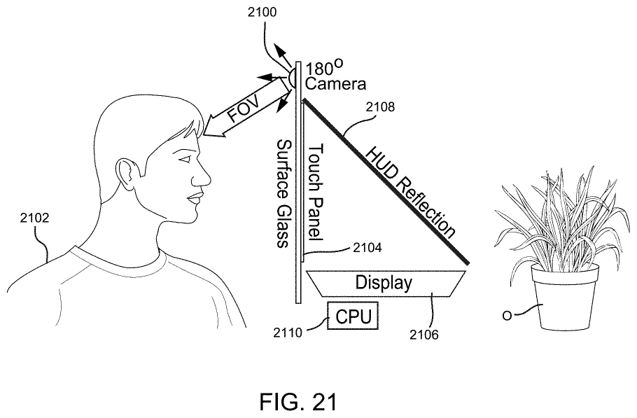

As indicated above, the technology described herein may be used in connection with head-up displays. FIG. 21 shows an example in this regard. That is, in FIG. 21, a front-facing camera 2100 is used to determine the perspective of the user 2102, while a target-facing camera is used to identify what the user 2102 might be seeing (e.g., object O) when interacting with the touch panel 2104. An example information display may be provided by a head-up display projector 2106 that provides an image to be reflected by the HUD reflector 2108 under the control of the CPU 2110.

### Other Example Use Cases

The technology disclosed herein may be used in connection with a wide variety of different use cases, and the specific examples set forth above are non-exhaustive. In general, any place where there is something of interest behind a barrier or the like, a transparent touch interface can be used to get a user's attention and provide for novel and engaging interactive experiences. Touch functionality may be integrated into such barriers. Barriers in this sense may be flat, curved, or otherwise shaped and may be partial or complete barriers that are transparent at least at expected interaction locations. Integrated and freestanding wall use cases include, for example, retail storefronts, retail interior sales displays, museums/zoos/historical sites, tourist sites/scenic overlooks/wayfinding locations, sports stadiums, industrial monitoring settings/control rooms, and/or the like. Small and medium punched units (vitrines and display cases) may be used in, for example, retail display cases (especially for high-value and/or custom goods), museums/zoos, restaurant and grocery ordering counters, restaurant and grocery refrigeration, automated vending, transportation or other vehicles (e.g., in airplanes, cars, busses, boats, etc., and walls, displays, windows, or the like therein and/or thereon), gaming, and/or other scenarios. Custom solutions may be provided, for example, in public art, marketing/publicity event/performance, centerpiece, and/or other settings. In observation areas, for example, at least one transparent touch panel may be a barrier, and the selectable objects may be landmarks or other features viewable from the observation area (such as, for example, buildings, roads, natural features such as rivers and mountains, etc.). It will be appreciated that observation areas could be real or virtual. “Real” observation or lookout areas are known to be present in a variety of situations, ranging from manmade monuments to tall buildings to places in nature. However, virtual observation areas could be provided, as well, e.g., for cities that do not have tall buildings, for natural landscapes in valleys or the like, etc. In certain example embodiments, drones or the like may be used to obtain panoramic images for static interaction. In certain example embodiments, drones or the like could be controlled, e.g., for dynamic interactions.

A number of further user interface (UI), user experience (UX), and/or human-machine interaction techniques may be used in place of, or together with, the examples described above. The following description lists several of such concepts:

In certain example embodiments, graphics may be projected onto a surface such that they are in-perspective for the user viewing the graphics (e.g., when the user is not at a normal angle to the surface and/or the surface is not flat). This effect may be used to intuitively identify which visual information is going to which user, e.g., when multiple users are engaged with the system at once. In this way, certain example embodiments can target information to individual passersby. Advantageously, graphics usability can be increased from one perspective, and/or for a group of viewers in the same or similar area. The camera in the parallax system can identify whether it is a group or individual using the interface, and tailor the output accordingly.

Certain example embodiments may involve shifting perspective of graphics between two users playing a game (e.g., when the users are not at a normal angle to the surface or the surface is not flat). This effect may be useful in a variety of circumstances including, for example, when playing games where elements move back and forth between opponents (e.g., a tennis or paddle game, etc.). When a group of users interacts with the same display, the graphics can linger at each person's perspective. This can be done automatically, as each user in the group shifts to the “prime” perspective, etc. This may be applicable in a variety of scenarios including, for example, when game elements move from one player to another (such as when effects are fired or sent form one character to another as might be the case with a tennis ball, ammunition effects, magical spells, etc.), when game elements being interacted with by one character affect another (e.g., defusing a bomb game where one character passes the bomb over to the second character to begin their work, and the owner of the perspective changes with that handoff) when scene elements adopt the perspective of the user closest to the element (e.g., as a unicorn flying around a castle approaches a user, it comes into correct perspective for them), etc.

Certain example embodiments may involve tracking a user perspective across multiple tiled parallax-aware transparent touch panel units. This effect advantageously can be used to provide a contiguous data or other interactive experience (e.g., where the user is in the site map of the interface) even if the user is moving across a multi-unit parallax-aware installation. For instance, information can be made more persistent and usable throughout the experience. It also can be used as an interaction dynamic for games (e.g., involving matching up a projected shape to the perspective it is supposed to be viewed from). The user may for example have to move his/her body across multiple parallax units to achieve a goal, and this approach can aid in that.

Certain example embodiments are able to provide dominant eye identification workarounds. One issue is that the user is always receiving two misaligned perspectives (one in the right eye one in the left), and when the user makes touch selections, the user is commonly using only the perspective of the dominant eye, or they are averaging the view from both. Certain example embodiments can address this issue. For example, average eye position can be used. In this approach, instead of trying to figure out which eye is dominant, the detection can be based on the point directly between the eyes. This approach does not provide a direct sightline for either eye, but can improve touch detection in some instances by accommodating all eye dominances and by being consistent in use. It is mostly unnoticeable when quickly using the interface and encourages both eyes to be open. Another approach is to use one eye (e.g., right eye) only. In this example approach, the system may be locked into permanently only using only the right eye because two-thirds of the population are right-eye dominant. If consistent across all implementations, users should be able to adapt. In the right-eye only approach, noticeable error will occur for left-eye dominance, but this error is easily identified and can be adjusted for accordingly. This approach also may sometimes encourage users to close one eye while they are using the interfaces. Still another example approach involves active control, e.g., and determining which eye is dominant for the user while the user is using the system. In one example implementation, the user could close one eye upon approach and the computer vision system would identify that an eye was closed and use the open eye as the gaze position. Visual feedback may be used to upgrade the accuracy of these and/or other approaches. For example, by showing a highlight of where the system thinks the user is pointing can provide an indication of which eye the system is drawing the sightline from for the user. Hover, for example, can initiate the location of the highlight, giving the user time to fine-adjust the selection, then confirming the selection with a touch. This indicator could also initiate as soon as, and whenever, the system detects an eye/finger sightline. The system can learn over time and adapt to use average position, account for left or right eye dominance, etc.

In certain example embodiments, the touch interface may be used to rotate and change perspective of 3D and/or other projected graphics. For instance, a game player or 3D modeler manipulating an object may be able to rotate, zoom in/out, increase/decrease focal length (perspective/orthographic), etc. In the museum map example, for example, this interaction could change the amount of “relief” in the map texture (e.g., making it look flat, having the topography exaggerated, etc.). As another example, in the earlier example of passing a bomb from player to player, those players could examine the bomb from multiple angles in two ways, one, by moving around the object and letting their gaze drive the perspective changes, two, by interacting with touch to initiate gestures that could rotate/distort/visually manipulate the object to get similar effects.

The techniques of certain example embodiments can be used in connection with users' selecting each other in multisided parallax installations. For instance, if multiple individuals are engaging with a parallax interface from different sides, special effects can be initiated when they select the opposite user instead of, or as, an object of interest. For example, because the system is capturing the coordinates of both users, everything is in place to allow them to select each other for interaction. This can be used in collaborative games or education, to link an experience so that both parties get the same information, etc.

The techniques described herein also allow groups of users interacting with parallax-aware interfaces to use smartphone, tablets, and/or the like as interface elements thereto (e.g., where their screens are faced towards the parallax-aware interface). For example, the computer vision system could identify items displayed on the screens held by one user that the other users can select, the system can also change what is being displayed on those mobile displays as part of the interface experience, etc. This may enable a variety of effects including, for example, a “Simon Says” style game where users have to select (through the parallax interface) other users (or their mobile devices) based on what the other users have on their screen, etc. As another example, an information matching game may be provided where an information bubble projected onto a projection table (like the museum map concept) has to be matched to or otherwise be dragged and paired with a user based on what is displayed on their device. As another example, a bubble on the table could have questions, and when dragged to a user, the answer can be revealed. For this example, a display on the user of interest does not need to be present, but the mobile device can be used as an identifier.

It will be appreciated that modular systems may be deployed in the above-described and/or other contexts. The local controller, for example, may be configured to permit removal of transparent touch panels installed in the system and installation of new transparent touch panels, in certain example embodiments. In modular or other systems, multiple cameras, potentially with overlapping views, may be provided. Distinct but overlapping area of the viewing location may be defined for each said camera. One, two, or more cameras may be associated with each touch panel in a multi-touch panel system. In certain example embodiments, the viewable areas of plural cameras may overlap, and an image of the viewing location may be obtained as a composite from the at least one camera and the at least one additional camera. In addition, or in the alternative, in certain example embodiments, the coordinate spaces may be correlated and, if a face's position appears in the overlapping area (e.g., when there is a position coordinate in a similar location in both spaces), the assumption may be made that the same face is present. In such cases, coordinate from the touch sensor that the user is interacting with, or an average the two together, may be used together. This approach may be advantageous in terms of being less processor-intensive than some compositing approaches and/or may help to avoid visual errors present along a compositing line. These and/or other approaches may be used to track touch actions across multiple panels by a single user.

Any suitable touch panel may be used in connection with different example embodiments. This may include, for example, capacitive touch panels; resistive touch panels; laser-based touch panels; camera-based touch panels; infrared detection (including with IR light curtain touch systems); large-area transparent touch electrodes including, for example, a coated article including a glass substrate supporting a low-emissivity (low-E) coating, the low-E coating being patterned into touch electrodes; etc. See, for example, U.S. Pat. Nos. 10,082,920; 10,078,409; and 9,904,431, the entire contents of which are hereby incorporated herein by reference.

It will be appreciated that the perspective shifting and/or other techniques disclosed in U.S. Application Ser. No. 62/736,538, filed on Sep. 26, 2018, may be used in connection with example embodiments of this invention. The entire contents of the '538 application are hereby incorporated herein by reference.

Although certain example embodiments have been described as relating to glass substrates, it will be appreciated that other transparent panel types may be used in place of or together with glass. Certain example embodiments are described in connection with large area transparent touch interfaces. In general, these interfaces may be larger than a phone or other handheld device. Sometimes, these interfaces will be at least as big as a display case. Of course, it will be appreciated that the techniques disclosed herein may be used in connection with handheld devices such as smartphones, tablets, gaming devices, etc., as well as laptops, and/or the like.

As used herein, the terms “on,” “supported by,” and the like should not be interpreted to mean that two elements are directly adjacent to one another unless explicitly stated. In other words, a first layer may be said to be “on” or “supported by” a second layer, even if there are one or more layers therebetween.

In certain example embodiments, an augmented reality system is provided. At least one transparent touch panel at a fixed position is interposed between a viewing location and a plurality of objects of interest, each said object of interest having a respective location representable in a common coordinate system. At least one camera is oriented generally toward the viewing location. Processing resources include at least one processor and a memory. The processing resources are configured to determine, from touch-related data received from the at least one transparent touch panel, whether a touch-down event has taken place. The processing resources are configured to are further configured to, responsive to a determination that a touch-down event has taken place: determine, from the received touch-related data, touch coordinates associated with the touch-down event that has taken place; obtain an image of the viewing location from the at least one camera; calculate, from body tracking and/or a face recognized in the obtained image, gaze coordinates; transform the touch coordinates and the gaze coordinates into corresponding coordinates in the common coordinate system; determine whether one of the locations in the common coordinate system comes within a threshold distance of a virtual line extending from the gaze coordinates in the common coordinate system through and beyond the touch coordinates in the common coordinate system; and responsive to a determination that one of the locations in the common coordinate system comes within a threshold distance of a virtual line extending from the gaze coordinates in the common coordinate system through and beyond the touch coordinates in the common coordinate system, designate the object of interest associated with that one of the locations as a touched object and generate audio and/or visual output tailored for the touched object.

In addition to the features of the previous paragraph, in certain example embodiments, the locations of the objects of interest may be defined as the objects' centers, as two-dimensional projections of the outlines of the objects, and/or the like.

In addition to the features of either of the two previous paragraphs, in certain example embodiments, the obtained image may include multiple faces and/or bodies. The calculation of the gaze coordinates may include: determining which one of the multiple faces and/or bodies is largest in the obtained image; and calculating the gaze coordinates from the largest face and/or body. The calculation of the gaze coordinates alternatively or additionally may include determining which one of the multiple faces and/or bodies is largest in the obtained image, and determining the gaze coordinates therefrom. The calculation of the gaze coordinates alternatively or additionally may include determining which one of the multiple faces and/or bodies is closest to the at least one transparent touch panel, and determining the gaze coordinates therefrom. The calculation of the gaze coordinates alternatively or additionally may include applying movement tracking to determine which one of the faces and/or bodies is associated with the touch-down event, and determining the gaze coordinates therefrom. For instance, the movement tracking may include detecting the approach of an arm, and the determining of the gaze coordinates may depend on the concurrence of the detected approach of the arm with the touch-down event. The calculation of the gaze coordinates alternatively or additionally may include applying a z-sorting algorithm to determine which one of the faces and/or bodies is associated with the touch-down event, and determining the gaze coordinates therefrom.

In addition to the features of any of the three previous paragraphs, in certain example embodiments, the gaze coordinates may be inferred from the body tracking.

In addition to the features of any of the four previous paragraphs, in certain example embodiments, the body tracking may include head tracking.

In addition to the features of any of the five previous paragraphs, in certain example embodiments, the gaze coordinates may be inferred from the head tracking. For instance, the face may be recognized in and/or inferred from the head tracking. The head tracking may include face tracking in some instances.

In addition to the features of any of the six previous paragraphs, in certain example embodiments, the threshold distance may require contact with the virtual line.

In addition to the features of any of the seven previous paragraphs, in certain example embodiments, the virtual line may be extended to a virtual depth as least as far away from the at least one transparent panel as the farthest object of interest.

In addition to the features of any of the eight previous paragraphs, in certain example embodiments, the determination as to whether one of the locations in the common coordinate system comes within a threshold distance of a virtual line extending from the gaze coordinates in the common coordinate system through and beyond the touch coordinates in the common coordinate system may be detected via linear interpolation.

In addition to the features of any of the nine previous paragraphs, in certain example embodiments, a display device may be controllable to display the generated visual output tailored for the touched object.

In addition to the features of any of the 10 previous paragraphs, in certain example embodiments, a projector may be provided. For instance, the projector may be controllable to project the generated visual output tailored for the touched object onto the at least one transparent touch panel.

In addition to the features of any of the 11 previous paragraphs, in certain example embodiments, the generated visual output tailored for the touched object may be projected onto or otherwise displayed on an area of the at least one transparent touch panel that, when viewed from the gaze coordinates, does not overlap with and/or obscure the objects of interest; an area of the at least one transparent touch panel that, when viewed from the gaze coordinates, appears to be superimposed on the touched object; an area of the at least one transparent touch panel that, when viewed from the gaze coordinates, appears to be adjacent to, but not superimposed on, the touched object; a designated area of the at least one transparent touch panel, regardless of which object of interest is touched; the touched object; an area on a side of the at least one transparent touch panel opposite the viewing location; an area on a side of the at least one transparent touch panel opposite the viewing location, taking into account a shape and/or topography of the area being projected onto; and/or the like.

In addition to the features of any of the 12 previous paragraphs, in certain example embodiments, one or more lights (e.g., LED(s) or the like) may be activated as the generated visual output tailored for the touched object. For instance, in certain example embodiments, the one or more lights may illuminate the touched object.

In addition to the features of any of the 13 previous paragraphs, in certain example embodiments, one or more flat panel displays may be controllable in accordance with the generated visual output tailored for the touched object.

In addition to the features of any of the 14 previous paragraphs, in certain example embodiments, one or more mechanical components may be movable in accordance with the generated visual output tailored for the touched object.

In addition to the features of any of the 15 previous paragraphs, in certain example embodiments, the generated visual output tailored for the touched object may include text related to the touched object, video related to the touched object, and/or coloration (e.g., in registration with the touched object).

In addition to the features of any of the 16 previous paragraphs, in certain example embodiments, a proximity sensor may be provided. For instance, the at least one transparent touch panel may be controlled to gather touch-related data; the at least one camera is may be configured to obtain the image based on output from the proximity sensor; the proximity sensor may be activatable based on touch-related data indicative of a hover operation being performed; and/or the like.

In addition to the features of any of the 17 previous paragraphs, in certain example embodiments, the at least one camera may be configured to capture video. For instance, movement tracking may be implemented in connection with captured video; the obtained image may be extracted from captured video; and/or the like.

In addition to the features of any of the 18 previous paragraphs, in certain example embodiments, at least one additional camera may be oriented generally toward the viewing location. For instance, images obtained from the at least one camera and the at least one additional camera may be used to detect multiple distinct interactions with the at least one transparent touch panel. For instance, the viewable areas of the at least one camera and the at least one additional camera may overlap and the image of the viewing location may be obtained as a composite from the at least one camera and the at least one additional camera; the calculation of the gaze coordinates may include removing duplicate face and/or body detections obtained by the at least one camera and the at least one additional camera; etc.

In addition to the features of any of the 19 previous paragraphs, in certain example embodiments, the locations of the objects of interest may be fixed and defined within the common coordinate system prior to user interaction with the augmented reality system.

In addition to the features of any of the 20 previous paragraphs, in certain example embodiments, the locations of the objects of interest may be tagged with markers, and the determination of whether one of the locations in the common coordinate system comes within a threshold distance of a virtual line extending from the gaze coordinates in the common coordinate system through and beyond the touch coordinates in the common coordinate system may be performed in connection with the respective markers. The markers in some instances may be individually and independently movable.

In addition to the features of any of the 21 previous paragraphs, in certain example embodiments, the locations of the objects of interest may be movable in the common coordinate system as a user interacts with the augmented reality system.

In addition to the features of any of the 22 previous paragraphs, in certain example embodiments, the objects may be physical objects and/or virtual objects. For instance, virtual objects may be projected onto an area on a side of the at least one transparent touch panel opposite the viewing location, e.g., with the projecting of the virtual objects taking into account the shape and/or topography of the area.

In addition to the features of any of the 23 previous paragraphs, in certain example embodiments, the at least one transparent touch panel may be a window in a display case.

In addition to the features of any of the 24 previous paragraphs, in certain example embodiments, the at least one transparent touch panel may be a window in a storefront, free-standing glass wall at an in-store display, a barrier at an observation point, included in a vending machine, a window in a vehicle, and/or the like.

In addition to the features of any of the 25 previous paragraphs, in certain example embodiments, the at least one transparent touch panel may be a coated article including a glass substrate supporting a low-emissivity (low-E) coating, e.g., with the low-E coating being patterned into touch electrodes.

In addition to the features of any of the 26 previous paragraphs, in certain example embodiments, the at least one transparent touch panel may include capacitive touch technology.

In certain example embodiments, an augmented reality system is provided. A plurality of transparent touch panels are interposed between a viewing location and a plurality of objects of interest, with each said object of interest having a respective physical location representable in a common coordinate system. An event bus is configured to receive touch-related events published thereto by the transparent touch panels, with each touch-related event including an identifier of the transparent touch panel that published it. At least one camera is oriented generally toward the viewing location. A controller is configured to subscribe to the touch-related events published to the event bus and determine, from touch-related data extracted from touch-related events received over the event bus, whether a tap has taken place. The controller is further configured to, responsive to a determination that a tap has taken place: determine, from the touch-related data, touch coordinates associated with the tap that has taken place, the touch coordinates being representable in the common coordinate system; determine which one of the transparent touch panels was tapped; obtain an image of the viewing location from the at least one camera; calculate, from body tracking and/or a face recognized in the obtained image, gaze coordinates, the gaze coordinates being representable in the common coordinate system; determine whether one of the physical locations in the common coordinate system comes within a threshold distance of a virtual line extending from the gaze coordinates in the common coordinate system through and beyond the touch coordinates in the common coordinate system; and responsive to a determination that one of the physical locations in the common coordinate system comes within a threshold distance of a virtual line extending from the gaze coordinates in the common coordinate system through and beyond the touch coordinates in the common coordinate system, designate the object of interest associated with that one of the physical locations as a touched object and generate visual output tailored for the touched object.

In addition to the features of the previous paragraph, in certain example embodiments, each touch-related event may have an associated touch-related event type, with touch-related event types including tap, touch-down, touch-off, hover event types, and/or the like.

In addition to the features of either of the two previous paragraphs, in certain example embodiments, different transparent touch panels may emit events to the event bus with different respective topics.

In addition to the features of any of the three previous paragraphs, in certain example embodiments, the transparent touch panels may be modular, and the controller may be configured to permit removal of transparent touch panels installed in the system and installation of new transparent touch panels.

In addition to the features of any of the four previous paragraphs, in certain example embodiments, a plurality of cameras, each oriented generally toward the viewing location, may be provided. In some implementations, each said camera may have a field of view encompassing a distinct, non-overlapping area of the viewing location. In other implementations, each said camera may have a field of view encompassing a distinct but overlapping area of the viewing location.

In addition to the features of any of the five previous paragraphs, in certain example embodiments, each said camera may be associated with one of the transparent touch panels.

In addition to the features of any of the six previous paragraphs, in certain example embodiments, two of said cameras may be associated with each one of the transparent touch panels.

In certain example embodiments, a method of using the system of any of the 33 preceding paragraphs is provided. In certain example embodiments, a method of configuring the system of any of the 33 preceding paragraphs is provided. In certain example embodiments, there is provided a non-transitory computer readable storage medium tangibly storing a program including instructions that, when executed by a computer, carry out one or both of such methods. In certain example embodiments, there is provided a controller for use with the system of any of the 33 preceding paragraphs. In certain example embodiments, there is provided a transparent touch panel for use with the system of any of the 33 preceding paragraphs.

Different end-devices/applications may be used in connection with the techniques of any of the 34 preceding paragraphs. These end-devices include, for example, storefront, in-store displays, museum exhibits, insulating glass (IG) window or other units, etc.

For instance, with respect to storefronts, certain example embodiments provide a storefront for a store, comprising such an augmented reality system, wherein the transparent touch panel(s) is/are windows for the storefront, and wherein the viewing location is external to the store. For instance, with respect to in-store displays, certain example embodiments provide an in-store display for a store, comprising such an augmented reality system, wherein the transparent touch panel(s) is/are incorporated into a case for the in-store display and/or behind a transparent barrier, and wherein the objects of interest are located in the case and/or behind the transparent barrier. For instance, with museum exhibits, certain example embodiments provide a museum exhibit, comprising such an augmented reality system, wherein the transparent touch panel(s) at least partially surrounding the museum exhibit.

In addition to the features of the previous paragraph, in certain example embodiments, the objects of interest may be within the store.

In addition to the features of either of the two previous paragraphs, in certain example embodiments, the objects of interest may be user interface elements.

In addition to the features of any of the three previous paragraphs, in certain example embodiments, user interface elements may be used to prompt a visual change to an article displayed in the end-device/arrangement.

In addition to the features of any of the four previous paragraphs, in certain example embodiments, a display device may be provided, e.g., with the article being displayed via the display device.

In addition to the features of any of the five previous paragraphs, in certain example embodiments, interaction with user interface elements may prompt a visual change to a projection-mapped article displayed in the end-device/arrangement, a visual change to an article displayed via a mobile device of a user, and/or the like.

In addition to the features of any of the six previous paragraphs, in certain example embodiments, in museum exhibit applications for example, the visual change may take into account a shape and/or topography of the article being projected onto.

In addition to the features of any of the seven previous paragraphs, in certain example embodiments, in museum exhibit applications for example, the museum exhibit may include a map.

In addition to the features of any of the eight previous paragraphs, in certain example embodiments, in museum exhibit applications for example, user interface elements may be points of interest on a map.

In addition to the features of any of the nine previous paragraphs, in certain example embodiments, in museum exhibit applications for example, the generated visual output tailored for the touched object may include information about a corresponding selected point of interest.

In addition to the features of any of the 10 previous paragraphs, in certain example embodiments, in museum exhibit applications for example, the generated visual output tailored for the touched object may be provided in an area and in an orientation perceivable by the user that does not significantly obstruct other areas of the display.

In addition to the features of any of the 11 previous paragraphs, in certain example embodiments, in museum exhibit applications for example, the location and/or orientation of the generated visual output may be determined via the location of the user in connection with the gaze coordinate calculation.

For The IG window or other unit configurations, for example, at least one transparent touch panel may be an outermost substrate therein, the at least one transparent touch panel may be spaced apart from a glass substrate in connection with a spacer system, the at least one transparent touch panel may be laminated to at least one substrate and spaced apart from another glass substrate in connection with a spacer system, etc.

While the invention has been described in connection with what is presently considered to be the most practical and preferred embodiment, it is to be understood that the invention is not to be limited to the disclosed embodiment and/or deposition techniques, but on the contrary, is intended to cover various modifications and equivalent arrangements included within the spirit and scope of the appended claims.

1. An augmented reality system, comprising:
at least one transparent touch panel interposed at a fixed position between a viewing location and a plurality of objects of interest, each said object of interest having a respective location representable in a common coordinate system;
at least one camera oriented generally toward the viewing location; and
processing resources including at least one processor and a memory, the processing resources being configured to:
determine, from touch-related data received from the at least one transparent touch panel, whether a touch-down event has taken place; and
responsive to a determination that a touch-down event has taken place:
determine, from the received touch-related data, touch coordinates associated with the touch-down event that has taken place;
obtain an image of the viewing location from the at least one camera;
calculate, from body tracking and/or a face recognized in the obtained image, gaze coordinates;
transform the touch coordinates and the gaze coordinates into corresponding coordinates in the common coordinate system;
determine whether one of the locations in the common coordinate system comes within a threshold distance of a virtual line extending from the gaze coordinates in the common coordinate system through and beyond the touch coordinates in the common coordinate system; and
responsive to a determination that one of the locations in the common coordinate system comes within a threshold distance of a virtual line extending from the gaze coordinates in the common coordinate system through and beyond the touch coordinates in the common coordinate system, designate the object of interest associated with that one of the locations as a touched object and generate audio and/or visual output tailored for the touched object.

2. The system of claim 1, wherein the locations of the objects of interest are defined as the objects' centers.

3. The system of claim 1, wherein the locations of the objects of interest are defined as two-dimensional projections of the outlines of the objects.

4. The system of claim 1, wherein the obtained image includes multiple faces and/or bodies and the calculation of the gaze coordinates includes:
determining which one of the multiple faces and/or bodies is largest in the obtained image; and
calculating the gaze coordinates from the largest face and/or body.

5. The system of claim 1, wherein:
the obtained image includes multiple faces and/or bodies; and
the calculation of the gaze coordinates includes determining which one of the multiple faces and/or bodies is largest in the obtained image, and determining the gaze coordinates therefrom.

6. The system of claim 1, wherein:
the obtained image includes multiple faces and/or bodies; and
the calculation of the gaze coordinates includes determining which one of the multiple faces and/or bodies is closest to the at least one transparent touch panel, and determining the gaze coordinates therefrom.

7. The system of claim 1, wherein:
the obtained image includes multiple faces and/or bodies; and
the calculation of the gaze coordinates includes applying movement tracking to determine which one of the faces and/or bodies is associated with the touch-down event, and determining the gaze coordinates therefrom.

8. The system of claim 7, wherein the movement tracking includes detecting the approach of an arm, and wherein the determining of the gaze coordinates depends on the concurrence of the detected approach of the arm with the touch-down event.

9-13. (canceled)

14. The system of claim 1, wherein:
the obtained image includes multiple faces and/or bodies; and
the calculation of the gaze coordinates includes applying a z-sorting algorithm to determine which one of the faces and/or bodies is associated with the touch-down event, and determining the gaze coordinates therefrom.

15. The system of claim 1, wherein the threshold distance requires contact with the virtual line.

16. The system of claim 1, wherein the virtual line is extended to a virtual depth as least as far away from the at least one transparent panel as the farthest object of interest.

17-19. (canceled)

20. The system of claim 1, further comprising a projector, wherein the projector is controllable to project the generated visual output tailored for the touched object onto the at least one transparent touch panel.

21. The system of claim 20, wherein the generated visual output tailored for the touched object is projected onto an area of the at least one transparent touch panel that, when viewed from the gaze coordinates, does not overlap with and/or obscure the objects of interest.

22. The system of claim 20, wherein the generated visual output tailored for the touched object is projected onto an area of the at least one transparent touch panel that, when viewed from the gaze coordinates, appears to be superimposed on the touched object.

23. The system of claim 20, wherein the generated visual output tailored for the touched object is projected onto an area of the at least one transparent touch panel that, when viewed from the gaze coordinates, appears to be adjacent to, but not superimposed on, the touched object.

24. The system of claim 20, wherein the generated visual output tailored for the touched object is projected onto a designated area of the at least one transparent touch panel, regardless of which object of interest is touched.

25-32. (canceled)

33. The system of claim 1, wherein the generated visual output tailored for the touched object includes text related to the touched object.

34. The system of claim 1, wherein the generated visual output tailored for the touched object includes video related to the touched object.

35. The system of claim 1, wherein the generated visual output tailored for the touched object includes coloration.

36-37. (canceled)

38. The system of claim 1, further comprising a proximity sensor, wherein the at least one transparent touch panel is controlled to gather touch-related data and/or the at least one camera is configured to obtain the image based on output from the proximity sensor.

39. The system of claim 1, further comprising a proximity sensor, wherein the proximity sensor is activatable based on touch-related data indicative of a hover operation being performed.

40. The system of claim 1, wherein the at least one camera is configured to capture video.

41. The system of claim 40, wherein movement tracking is implemented in connection with captured video.

42. The system of claim 40, wherein the obtained image is extracted from captured video.

43. The system of claim 1, further comprising at least one additional camera oriented generally toward the viewing location.

44. The system of claim 43, wherein images obtained from the at least one camera and the at least one additional camera are used to detect multiple distinct interactions with the at least one transparent touch panel.

45. The system of claim 43, wherein the viewable areas of the at least one camera and the at least one additional camera overlap and wherein the image of the viewing location is obtained as a composite from the at least one camera and the at least one additional camera.

46. The system of claim 45, wherein the calculation of the gaze coordinates includes removing duplicate face and/or body detections obtained by the at least one camera and the at least one additional camera.

47. The system of claim 1, wherein the locations of the objects of interest are fixed and defined within the common coordinate system prior to user interaction with the augmented reality system.

48. The system of claim 1, wherein the locations of the objects of interest are tagged with markers, and
wherein the determination of whether one of the locations in the common coordinate system comes within a threshold distance of a virtual line extending from the gaze coordinates in the common coordinate system through and beyond the touch coordinates in the common coordinate system is performed in connection with the respective markers.

49. The system of claim 48, wherein the markers are individually and independently movable.

50. The system of claim 1, wherein the locations of the objects of interest are movable in the common coordinate system as a user interacts with the augmented reality system.

51. The system of claim 1, wherein the objects are physical objects.

52. The system of claim 1, wherein the objects are virtual objects.

53-54. (canceled)

55. The system of claim 1, wherein the at least one transparent touch panel is a window in a display case, a window in a storefront, or free-standing glass wall at an in-store display, a barrier at an observation point, included in a vending machine, or a window in a vehicle.

56-59. (canceled)

60. The system of claim 1, wherein the at least one transparent touch panel is a coated article including a glass substrate supporting a low-emissivity (low-E) coating, the low-E coating being patterned into touch electrodes.

61. (canceled)

62. An augmented reality system, comprising:
a plurality of transparent touch panels interposed between a viewing location and a plurality of objects of interest, each said object of interest having a respective physical location representable in a common coordinate system;
an event bus configured to receive touch-related events published thereto by the transparent touch panels, each touch-related event including an identifier of the transparent touch panel that published it;
at least one camera oriented generally toward the viewing location; and
a controller configured to subscribe to the touch-related events published to the event bus and:
determine, from touch-related data extracted from touch-related events received over the event bus, whether a tap has taken place; and
responsive to a determination that a tap has taken place:
determine, from the touch-related data, touch coordinates associated with the tap that has taken place, the touch coordinates being representable in the common coordinate system;
determine which one of the transparent touch panels was tapped;
obtain an image of the viewing location from the at least one camera;
calculate, from body tracking and/or a face recognized in the obtained image, gaze coordinates, the gaze coordinates being representable in the common coordinate system;
determine whether one of the physical locations in the common coordinate system comes within a threshold distance of a virtual line extending from the gaze coordinates in the common coordinate system through and beyond the touch coordinates in the common coordinate system; and
responsive to a determination that one of the physical locations in the common coordinate system comes within a threshold distance of a virtual line extending from the gaze coordinates in the common coordinate system through and beyond the touch coordinates in the common coordinate system, designate the object of interest associated with that one of the physical locations as a touched object and generate visual output tailored for the touched object.

63. The system of claim 62, wherein each touch-related event has an associated touch-related event type, touch-related event types including tap, touch-down, touch-off, and hover event types.

64. The system of claim 62, wherein different transparent touch panels emit events to the event bus with different respective topics.

65. The system of claim 62, wherein the transparent touch panels are modular and wherein the controller is configured to permit removal of transparent touch panels installed in the system and installation of new transparent touch panels.

66. The system claim 62, further comprising a plurality of cameras, each oriented generally toward the viewing location.

67. The system of claim 66, wherein each said camera has a field of view encompassing a distinct, non-overlapping area of the viewing location.

68. The system of claim 66, wherein each said camera has a field of view encompassing a distinct but overlapping area of the viewing location.

69-70. (canceled)

71. A method of using an augmented reality system including at least one transparent touch panel interposed at a fixed position between a viewing location and a plurality of objects of interest, each said object of interest having a respective location representable in a common coordinate system, the method comprising:
determining, from touch-related data received from the at least one transparent touch panel, whether a touch-down event has taken place; and
responsive to a determination that a touch-down event has taken place:
determining, from the received touch-related data, touch coordinates associated with the touch-down event that has taken place;
obtaining an image of the viewing location from at least one camera oriented generally toward the viewing location:
calculating, from body tracking and/or a face recognized in the obtained image, gaze coordinates;
transforming the touch coordinates and the gaze coordinates into corresponding coordinates in the common coordinate system;
determining whether one of the locations in the common coordinate system comes within a threshold distance of a virtual line extending from the gaze coordinates in the common coordinate system through and beyond the touch coordinates in the common coordinate system; and
responsive to a determination that one of the locations in the common coordinate system comes within a threshold distance of a virtual line extending from the gaze coordinates in the common coordinate system through and beyond the touch coordinates in the common coordinate system, designating the object of interest associated with that one of the locations as a touched object and generating audio and/or visual output tailored for the touched object.

72. (canceled)

73. A non-transitory computer readable storage medium tangibly storing a program including instructions that, when executed by a computer, carry out the method of claim 71.

74-102. (canceled)
